(19) United States
(12) Patent Application Publication
(10) Pub. No.: US 2025/0365768 A1
(43) Pub. Date: Nov. 27, 2025

(54) METHOD AND APPARATUS FOR PERFORMING LISTEN BEFORE TALK FOR UWB COMMUNICATION

(71) Applicant: SAMSUNG ELECTRONICS CO., LTD., Suwon-si (KR)

(72) Inventors: Youngwan SO, Suwon-si (KR); Mingyu LEE, Suwon-si (KR); Taeyoung HA, Suwon-si (KR)

(21) Appl. No.: 19/219,634

(22) Filed: May 27, 2025

(30) Foreign Application Priority Data
May 27, 2024 (KR) 10-2024-0068887
Jun. 27, 2024 (KR) 10-2024-0084634

(51) Int. Cl. H04W 74/0816; H04B 1/7163; H04W 74/06

(52) U.S. Cl. CPC H04W 74/0816; H04B 1/7163; H04W 74/06

(57) ABSTRACT

A method of a first ultra-wideband (UWB) device operating as an initiator, according to an embodiment of the disclosure, may comprise performing clear channel assessment (CCA) for a plurality of slots within a ranging round to measure a state of a channel, transmitting a poll message in a first ranging slot within the ranging round if it is determined, based on the CCA, that the channel is clear, and receiving, in a second ranging slot within the ranging round, a response message corresponding to the poll message from a second UWB device.

### CROSS-REFERENCE TO RELATED APPLICATIONS

This application is based on and claims priority under 35 U.S.C. § 119 to Korean Patent Application No. 10-2024-0068887, which was filed in the Korean Intellectual Property Office on May 27, 2024, and Korean Patent Application No. 10-2024-0084634, which was filed in the Korean Intellectual Property Office on Jun. 27, 2024, the entire disclosures of which are incorporated herein by reference.

### BACKGROUND

### 1. Field

The disclosure relates to ultra-wide band (UWB) communication and, more specifically, to a method for performing listen before talk (LBT) for UWB communication.

### 2. Description of Related Art

The Internet is evolving from the human-centered connection network by which humans create and consume information to the Internet of Things (IoT) network by which information is communicated and processed between things or other distributed components. Another arising technology is the Internet of Everything (IoE), which is a combination of the Big data processing technology and the IoT technology through, e.g., a connection with a cloud server. Implementing the IoT requires technical elements, such as sensing technology, a wired/wireless communication and network infrastructure, service interface and security technologies. A recent ongoing research for thing-to-thing connection is on techniques for sensor networking, machine-to-machine (M2M), or machine-type communication (MTC).

In the IoT environment may be offered intelligent Internet Technology (IT) services that collect and analyze the data generated by the things connected with one another to create human life a new value. The IoT may have various applications, such as the smart home, smart building, smart city, smart car or connected car, smart grid, health-care, or smart appliance industry, or state-of-art medical services, through conversion or integration of information technology (IT) techniques and various industries.

As wireless communication systems evolve to provide various services, a need arises for a method for effectively providing such services. For example, it is possible to use a ranging technique for measuring the distance between electronic devices using ultra-wide band (UWB).

The disclosure provides a method and device for performing LBT for UWB communication.

### SUMMARY

According to an embodiment of the disclosure, a method of a first ultra-wideband (UWB) device operating as an initiator may comprise performing clear channel assessment (CCA) for a plurality of slots within a ranging round to measure a state of a channel, transmitting a poll message in a first ranging slot within the ranging round if it is determined, based on the CCA, that the channel is clear, and receiving, in a second ranging slot within the ranging round, a response message corresponding to the poll message from a second UWB device.

According to an embodiment of the disclosure, a method of a second ultra-wideband (UWB) device operating as a responder may comprise receiving, in a first ranging slot within a ranging round, a poll message from a first UWB device based on a clear channel assessment (CCA) for a plurality of slots within the ranging round of the first UWB device, and transmitting, in a second ranging slot within the ranging round, a response message corresponding to the poll message to the first UWB device.

According to an embodiment of the disclosure, a first ultra-wideband (UWB) device operating as an initiator may comprise a transceiver, and a controller. The controller may perform clear channel assessment (CCA) for a plurality of slots within a ranging round to measure a state of a channel, control to transmit a poll message in a first ranging slot within the ranging round if it is determined, based on the CCA, that the channel is clear, and receive, in a second ranging slot within the ranging round, a response message corresponding to the poll message from a second UWB device.

According to an embodiment of the disclosure, a second ultra-wideband (UWB) device operating as a responder may comprise a transceiver, and a controller. The controller may receive, in a first ranging slot within a ranging round, a poll message from a first UWB device based on a clear channel assessment (CCA) for a plurality of slots within the ranging round of the first UWB device, and control to transmit, in a second ranging slot within the ranging round, a response message corresponding to the poll message to the first UWB device.

Through the embodiments of the disclosure, transmission and reception efficiency may be increased by performing optimal LBT operation during UWB communication.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example architecture of a UWB device according to an embodiment of the disclosure;

FIG. 2 illustrates an example configuration of a framework of a UWB device according to an embodiment of the disclosure;

FIG. 3 illustrates a method for performing communication by a plurality of electronic devices according to an embodiment of the disclosure;

FIG. 4 illustrates a structure of a UWB MAC frame according to an embodiment of the disclosure;

FIG. 5 illustrates a structure of a UWB PHY packet according to an embodiment of the disclosure;

FIG. 6 illustrates an example of a structure of a ranging block and round used for UWB ranging according to an embodiment of the disclosure;

FIG. 7 illustrates schematic operations of a DL-TDoA procedure according to an embodiment of the disclosure;

FIG. 8 illustrates an example of performing LBT in each slot unit according to an embodiment of the disclosure;

FIG. 9 illustrates an example of performing one LBT for a plurality of slots according to an embodiment of the disclosure;

FIG. 10 illustrates an example of performing round level LBT according to an embodiment of the disclosure;

FIG. 11 illustrates another example of performing round level LBT according to an embodiment of the disclosure;

FIG. 12 illustrates an example of performing LBT before transmitting a POLL message according to an embodiment of the disclosure;

FIG. 13 illustrates an example of performing LBT before transmitting a POLL message and a report message according to an embodiment of the disclosure;

FIG. 14 illustrates an example of a POLL message format according to an embodiment of the disclosure;

FIG. 15 illustrates an example of a response message format according to an embodiment of the disclosure;

FIG. 16A illustrates another example of performing LBT before transmitting a POLL message and a report message according to an embodiment of the disclosure;

FIG. 16B illustrates another example of performing LBT before transmitting a POLL message and a report message according to an embodiment of the disclosure;

FIG. 16C illustrates another example of performing LBT before transmitting a POLL message and a report message according to an embodiment of the disclosure;

FIG. 17 illustrates a configuration of a first electronic device according to an embodiment of the disclosure; and

FIG. 18 illustrates a configuration of a second electronic device according to an embodiment of the disclosure.

### DETAILED DESCRIPTION

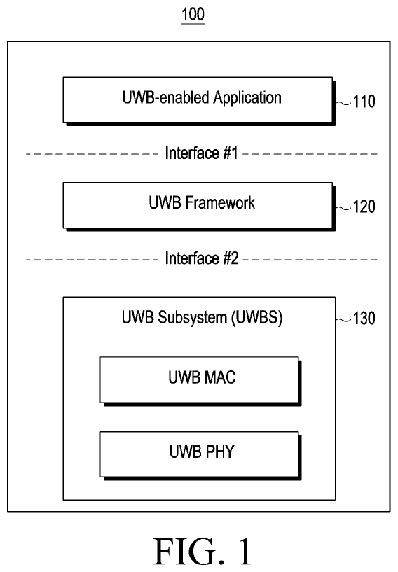

FIGS. 1 through 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the present disclosure are described in detail with reference to the accompanying drawings.

In describing embodiments, the description of technologies that are known in the art and are not directly related to the present disclosure is omitted. This is for further clarifying the gist of the present disclosure without making it unclear.

For the same reasons, some elements may be exaggerated or schematically shown. The size of each element does not necessarily reflect the real size of the element. The same reference numeral is used to refer to the same element throughout the drawings.

Advantages and features of the present disclosure, and methods for achieving the same may be understood through the embodiments to be described below taken in conjunction with the accompanying drawings. However, the present disclosure is not limited to the embodiments disclosed herein, and various changes may be made thereto. The embodiments disclosed herein are provided only to inform one of ordinary skilled in the art of the category of the present disclosure. The present disclosure is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, “unit” is not limited to software or hardware. A “unit” may be configured in a storage medium that may be addressed or may be configured to execute one or more processors. Accordingly, as an example, a “unit” includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the “units” may be combined into smaller numbers of components and “units” or further separated into additional components and “units.” Further, the components and “units” may be implemented to execute one or more CPUs in a device or secure multimedia card. According to embodiments of the disclosure, a “ . . . unit” may include one or more processors.

As used herein, the term “device” or “electronic device” may also be referred to as a mobile station (MS), user equipment (UE), user terminal (UT), terminal, wireless terminal, access terminal (AT), subscriber unit, subscriber station (SS), wireless device, wireless communication device, wireless transmit/receive unit (WTRU), mobile node, or mobile or may be referred to in other terms. Various embodiments of the terminal may include cellular phones, smart phones with wireless communication capabilities, personal digital assistants (PDAs) with wireless communication capabilities, wireless modems, portable computers with wireless communication capabilities, capturing/recording/shooting/filming devices, such as digital cameras, having wireless communication capabilities, game players with wireless communications capabilities, music storage and playback home appliances with wireless communications capabilities, Internet home appliances capable of wireless Internet access and browsing, or portable units or terminals incorporating combinations of those capabilities. Further, the terminal may include a machine to machine (M2M) terminal and a machine-type communication (MTC) terminal/device, but is not limited thereto.

Hereinafter, the operational principle of the disclosure is described below with reference to the accompanying drawings. When determined to make the subject matter of the disclosure unnecessarily unclear, the detailed description of known functions or configurations may be skipped in describing embodiments of the disclosure. The terms as used herein are defined considering the functions in the present disclosure and may be replaced with other terms according to the intention or practice of the user or operator. Therefore, the terms should be defined based on the overall disclosure.

Hereinafter, embodiments of the present disclosure are described in detail with reference to the accompanying drawings. Further, although a communication system using UWB is described in connection with embodiments of the present disclosure, as an example, embodiments of the present disclosure may also apply to other communication systems with similar technical background or features. For example, a communication system using Bluetooth or ZigBee may be included therein. Further, embodiments of the present disclosure may be modified in such a range as not to significantly depart from the scope of the present disclosure under the determination by one of ordinary skill in the art and such modifications may be applicable to other communication systems.

When determined to make the subject matter of the present disclosure unclear, the detailed description of the known art or functions may be skipped. The terms as used herein are defined considering the functions in the present disclosure and may be replaced with other terms according to the intention or practice of the user or operator. Therefore, the terms should be defined based on the overall disclosure.

In general, wireless sensor network technology is largely divided into a wireless local area network (WLAN) technology and a wireless personal area network (WPAN) technology according to the recognition distance. In this case, WLAN is a technology based on IEEE 802.11 which enables access to the backbone network within a radius of about 100 m. WPAN is a technology based on IEEE 802.15 which includes Bluetooth, ZigBee, and ultra-wideband (UWB). A wireless network in which such a wireless network technology is implemented may include a plurality of electronic devices.

According to the definitions by the Federal Communications Commission (FCC), UWB may refer to a wireless communication technology that uses a bandwidth of 500 MHz or more or a bandwidth corresponding to a center frequency of 20% or more. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known).

The terminology used herein is provided for a better understanding of the disclosure, and changes may be made thereto without departing from the technical spirit of the disclosure.

“Application dedicated file (ADF)” may be, e.g., a data structure in an application data structure that may host an application or application specific data.

“Application protocol data unit (APDU)” may be a command and a response used when communicating with the application data structure in the UWB device.

“Application specific data” may be, e.g., a file structure having a root level and an application level including UWB controlee information and UWB session data for a UWB session.

“Controller” may be a ranging device that defines and controls ranging control messages (RCM) (or control messages).

“Controlee” may be a ranging device using a ranging parameter in the RCM (or control message) received from the controller.

Unlike “static STS,” “dynamic scrambled timestamp sequence (STS) mode” may be an operation mode in which the STS is not repeated during a ranging session. In this mode, the STS may be managed by the ranging device, and the ranging session key that generates STS may be managed by a secure component.

“Applet” may be, e.g., an applet executed on the secure component including UWB parameters and service data. In this disclosure, Applet may be a FiRa Applet defined by FiRa.

“Ranging device” may be a device capable of performing UWB ranging. In the disclosure, the ranging device may be an enhanced ranging device (ERDEV) defined in the IEEE 802.15 standard or a FiRa Device defined by FiRa. The ranging device may be referred to as a UWB device.

“UWB-enabled application” may be an application for UWB service. For example, the UWB-enabled application may be an application using a framework API for configuring an OOB Connector, a secure service, and/or a UWB service for a UWB session. In this disclosure, “UWB-enabled application” may be abbreviated as an application or a UWB application. UWB-enabled application may be a FiRa-enabled application defined by FiRa.

“Framework” may be a component that provides access to profiles, individual-UWB configuration and/or notifications. “Framework” may be, e.g., a collection of logical software components including profile manager, OOB connector, secure service, and/or UWB service. In the disclosure, the framework may be a FiRa framework defined by FiRa.

“OOB connector” may be a software component for establishing an out-of-band (OOB) connection (e.g., BLE connection) between ranging devices. In the disclosure, the OOB connector may be a FiRa OOB connector defined by FiRa.

“Profile” may be a previously defined set of UWB and OOB configuration parameters. In the disclosure, profile may be a FiRa profile defined by FiRa.

“Profile manager” may be a software component that implements a profile available on the ranging device. In the disclosure, the profile manager may be a FiRa profile manager defined by FiRa.

“Service” may be an implementation of a use case that provides a service to an end-user.

“Smart ranging device” may be a ranging device that may implement an optional framework API. In the disclosure, the smart ranging device may be a FiRa smart device defined by FiRa.

“Global Dedicated File (GDF)” may be a root level of application specific data including data required to establish a USB session.

“Framework API” may be an API used by a UWB-enabled application to communicate with the framework.

“Initiator” may be a ranging device that initiates a ranging exchange.

“Object identifier (OID)” may be an identifier of the ADF in the application data structure.

“Out-of-band (OOB)” may be data communication that does not use UWB as an underlying wireless technology.

“Ranging data set (RDS)” may be data (e.g., UWB session key, session ID, etc.) required to establish a UWB session when it may perform to protect confidentiality, authenticity and integrity.

“Responder” may be a ranging device that responds to the initiator in a ranging exchange.

“STS” may be a ciphered sequence for increasing the integrity and accuracy of ranging measurement timestamps. The STS may be generated from the ranging session key.

“Secure channel” may be a data channel that prevents overhearing and tampering.

“Secure component” may be an entity (e.g., SE or TEE) having a defined security level that interfaces with UWBS for the purpose of providing RDS to UWBS, e.g., when dynamic STS is used.

“Secure element (SE)” may be a tamper-resistant secure hardware component that may be used as a Secure Component in the ranging device.

“Secure ranging” may be ranging based on STS generated through a strong encryption operation.

“Secure service” may be a software component for interfacing with a secure component, such as a secure element or trusted execution environment (TEE).

“Service applet” may be an applet on a secure component that handles service specific transactions.

“Service data” may be data defined by a service provider that may be transferred between two ranging devices to implement a service.

“Service provider” may be an entity that defines and provides hardware and software required to provide a specific service to an end-user.

“Static STS mode” is an operation mode in which STS is repeated during a session, and may not be managed by the secure component.

“Secure UWB service (SUS) applet” may be an applet on the SE that communicates with the applet to retrieve data may be performed to enable secure UWB sessions with other ranging devices. The SUS Applet may transfer corresponding data (information) to the UWBS.

“UWB service” may be a software component that provides access to the UWBS.

“UWB session” may be a period from when the controller and the controlee start communication through UWB until the communication stops. A UWB session may include ranging, data transfer, or both ranging and data transfer.

“UWB session ID” may be an ID (e.g., a 32-bit integer) that identifies the UWB session, shared between the controller and the controller.

“UWB session key” may be a key used to protect the UWB session. The UWB session Key may be used to generate the STS. In this disclosure, the UWB session key may be a UWB ranging session key (URSK), and may be abbreviated as a session key.

“UWB subsystem (UWBS)” may be a hardware component implementing the UWB PHY and MAC layers specifications. UWBS may have an interface to framework and an interface to secure component to search for RDS. In this disclosure, the UWB PHY and MAC specifications may be, e.g., FiRa PHY and FiRa MAC specifications defined by FiRa referring to the IEEE 802.15 standard.

“UWB message” may be a message including a payload IE transmitted by the UWB device (e.g., ERDEV).

The “ranging message” may be a message transmitted by a UWB device (e.g., ERDEV) in a UWB ranging procedure. For example, the ranging message may be a message, such as a ranging initiation message (RIM), a ranging response message (RRM), a ranging final message (RFM), or a measurement report message (MRM), transmitted by a UWB device (e.g., ERDEV) in a specific phase of the ranging round. A ranging message may include one or more UWB messages. If necessary, a plurality of ranging messages may be merged into one message. For example, in the case of non-deferred DS-TWR ranging, RFM and MRM may be merged into one message in a ranging final phase.

“Payload IE” may be referred to as a payload information element and may be included in the MAC payload of the UWB MAC frame defined in the IEEE 802.15 standard. The MAC payload may include a plurality of payload IEs.

“Data transferIE” may be an additional payload IE for transmitting application data. Application data may be data transferred from a framework or application above the UWB MAC Layer. The data transfer IE may be used in the procedure for ranging between the initiator and the responder. In this case, the ranging message may include at least one or both of the payload IE for ranging and the data transfer IE for application data transfer. For example, the data transfer IE may be included and transmitted as part of the payload IE of the MAC payload of a ranging initiation message (RIM) for ranging, a ranging response message (RRM), a ranging final message (RFM), a measurement report message (MRM) and ranging result report message (RRRM). The data transfer IE may be transferred to the payload IE of the MAC payload of the DTM. For example, the data transfer IE may be transferred, together with the DTM payload IE, while being attached to the MAC payload portion of the poll DTM, response DTM, and final DTM.

“UWB channel” may be one of candidate UWB channels allocated for UWB communication. Candidate UWB channels allocated for UWB communication may be channels allocated for UWB communication defined in the IEEE 802.15 standard. The UWB channel may be used for UWB ranging and/or transaction. For example, the UWB channel may be used for transmission/reception of a ranging frame RFRAME and/or transmission/reception of a data frame.

“Narrow band (NB) channel” may be a channel having a narrower bandwidth than the UWB channel. In an embodiment, the NB channel may be a subchannel of one of the candidate NB channels allocated for communications in a separate band, such as the UNII-3 or UNII-5 frequency bands, from UWB communication. Alternatively, the NB channel may be a subchannel of one of the candidate UWB channels allocated for UWB communication. Candidate UWB channels allocated for UWB communication may be channels allocated for UWB communication defined in the IEEE 802.15 standard. The NB channel may be used for advertising, device discovery, and/or connection setup for additional parameter negotiation/authentication. For example, the NB channel may be used for transmission and reception of an advertisement message, an additional advertising message, a connection request message, and/or a connection confirmation message.

“One-way ranging (OWR)” may be a ranging scheme using a time difference of arrival (TDoA) localization method. The TDoA method corresponds to a method for locating a mobile device (tag device) based on a relative arrival time of a single message or multiple messages. For a description of OWR (TDoA), reference may be made to the description of IEEE 802.15.4z. As an example of the OWR scheme, an uplink (UL)-TDoA scheme may be included.

“Two-way ranging (TWR)” may be a ranging scheme capable of estimating a relative distance between two devices by measuring time of flight (ToF) through the exchange of ranging messages between the two devices. The TWR scheme may be one of double-sided two-way ranging (DS-TWR) and single-sided two-way ranging (SS-TWR). SS-TWR may be a procedure for performing ranging through one round-trip time measurement. DS-TWR may be a procedure for performing ranging through two round-trip time measurements. For a description of SS-TWR and DS-TWR, reference may be made to the description of IEEE 802.15.4z.

“DL-TDoA” may be called Downlink Time Difference of Arrival (DL-TDoA), reverse TDoA, and its default operation may be for the user equipment (UE) (tag device) to overhear the message of the anchor device while a plurality of anchor devices broadcast or exchange messages. The UE performing the DL-TDoA operation may overhear the messages transmitted by the two anchor devices to calculate a Time Difference of Arrival (TDoA) proportional to the difference between the distances between each anchor device and the UE. The UE may calculate a relative distance to the anchor device by using TDoA with several pairs of anchor devices and use it for positioning. The operation of the anchor device for DL-TDoA may be similar to that of double side-two way ranging (DS-TWR) defined in the IEEE 802.15 standard and may further include other useful time information so that the UE may calculate the TDoA. In the disclosure, DL-TDoA may be referred to as DL-TDoA localization.

“Anchor device” may be referred to as an anchor, a UWB anchor or a UWB anchor device and may be a UWB device deployed in a specific location to provide a positioning service. For example, the anchor device may be a UWB device installed by a service provider on a wall, ceiling, structure, or the like in a room to provide an indoor positioning service. Anchor devices may be divided into initiator anchors and responder anchors according to the order and role of transmitting messages.

“Initiator anchor” may be referred to as an initiator UWB anchor, an initiator anchor device, or the like and may announce the start of a specific ranging round. The initiator anchor may schedule a ranging slot for the responder anchors operating in the same ranging round to respond. The initiation message of the initiator anchor may be referred to as an initiator downlink TDoA message (DTM) or poll message. The initiation message of the initiator anchor may include a transmission timestamp. The initiator anchor may additionally transfer an end message after receiving responses from the responder anchors. The end message of the initiator anchor may be referred to as final DTM or Final message. The end message may include the time of the reply to the messages sent by the responder anchors. The end message may include a transmission timestamp.

“Responder anchor” may also be referred to as a responder UWB anchor, a responder UWB anchor device, a responder anchor device, etc. The responder anchor may be a UWB anchor responding to the initiation message of the initiator anchor. The message with which the responder anchor responds may include the time of reply to the initiation message. The message with which the responder anchor responds may be referred to as a responder DTM or a Response message. The response message of the responder anchor may include a transmission timestamp.

“Cluster” may mean a set of UWB anchors covering a specific area. The cluster may be composed of an initiator UWB anchor and responder UWB anchors responding thereto. For 2D positioning, one initiator UWB anchor and at least two responder UWB anchors are typically required and, for 3D positioning, one initiator UWB anchor and at least three responder UWB anchors are required. If the initiator UWB anchor and the responder UWB anchor may be accurately time-synchronized through a separate wired/wireless connection, one initiator UWB anchor and two responder UWB anchors are required for 2D positioning, and one initiator UWB anchor and three responder UWB anchors are required for 3D positioning. Unless otherwise stated, it is assumed that there is no separate device for wired/wireless time synchronization between UWB anchors. The cluster area may be a space formed by the UWB anchors constituting the cluster. To support the positioning service for a wide area, a plurality of clusters may be configured to provide the positioning service to the UE. In this disclosure, a cluster may be referred to as a cell. In the disclosure, the operation of the cluster may be understood as the operation of anchor(s) belonging to the cluster.

“Active ranging round” may be a ranging round operating in an active state. In an active ranging round, anchor devices may exchange DL-TDoA messages, and the tag device (UE) may overhear the message transmitted by the anchor device. In this disclosure, the active ranging round may be referred to as an active round.

“In-active ranging round” may be a ranging round operating in an in-active state or sleep state. In the in-active ranging round, anchor devices do not exchange DL-TDoA messages, and the tag device UE may be in a sleep state. In this disclosure, the in-active ranging round may be referred to as a sleep ranging round, an in-active round, or a sleep round.

“Reference clock” may refer to one common clock that allows the anchors (DT-anchors) and tags (DT-tags) constituting the downlink TDoA system to operate in sync with each other and allows the DT-tag to obtain a correct TDoA value. Since DT-anchors and DT-tags are different terminals and operate with different crystal oscillators, there may be a slight difference in clock speed and, since the power supply time differs, the clock origin may be different. Therefore, a mechanism to maintain the same clock throughout the system is required, which may be called time synchronization. Time synchronization between the components in the cluster may be referred to as intra-cluster synchronization, and the operation in which the plurality of responder anchors constituting one cluster sync with the clock of the initiator anchor of the same cluster may be referred to as intra-cluster synchronization. Synchronizing between adjacent clusters may be referred to as inter-cluster synchronization, and maintaining the same ranging block structure between the initiator anchors of the adjacent clusters may be referred to as inter-cluster synchronization. In the cluster, the clock of the initiator anchor may be a reference clock and, in the entire system, the clock of one specific initiator anchor may be a reference clock.

When determined to make the subject matter of the present disclosure unnecessarily unclear, the detailed description of related known functions or features may be skipped in describing the disclosure.

Hereinafter, various embodiments of the disclosure are described with reference to the accompanying drawings.

FIG. 1 illustrates an example architecture of a UWB device according to an embodiment of the disclosure.

In the disclosure, the UWB device 100 may be an electronic device supporting UWB communication. The UWB device 100 may be, e.g., a ranging device supporting UWB ranging. In an embodiment, the ranging device may be an enhanced ranging device (ERDEV) defined in the IEEE 802.15 standard or a FiRa Device defined by FiRa.

In the embodiment of FIG. 1, the UWB device 100 may interact with other UWB devices through a UWB session.

The UWB device 100 may implement a first interface (Interface #1) that is an interface between the UWB-enabled application 110 and the framework 120, and the first interface allows the UWB-enabled application 110 on the UWB device 100 to use the UWB capabilities of the UWB device 100 in a predetermined manner. In an embodiment, the first interface may be a framework API or a proprietary interface, but is not limited thereto.

The UWB device 100 may implement a second interface (Interface #2) that is an interface between the UWB framework 110 and the UWB subsystem (UWBS, 130). In an embodiment, the second interface may be a UWB Command Interface (UCI) or proprietary interface, but is not limited thereto.

Referring to FIG. 1, the UWB device 100 may include a UWB-enabled application 110, a framework (UWB framework) 120, and/or a UWBS 130 including a UWB MAC Layer and a UWB Physical Layer. Depending on the embodiment, some entities may not be included in the UWB device, or additional entities (e.g., security layer) may be further included.

The UWB-enabled application 110 may trigger establishment of a UWB session by a UWBS 130 through the first interface. The UWB-enabled application 110 may use one of previously defined profiles (profile). For example, the UWB-enabled application 110 may use one of the profiles defined in FiRa or a custom profile. The UWB-enabled application 110 may use the first interface to handle related events, such as service discovery, ranging notifications, and/or error conditions.

The framework 120 may provide access to Profiles, individual-UWB configuration and/or notifications. The framework 120 may support at least one of a function for UWB ranging and transaction execution, a function to provide an interface to the application and UWBS 130, or a function to estimate the location of the device 100. The framework 120 may be a set of software components. As described above, the UWB-enabled application 110 may interface with the framework 120 through the first interface, and the framework 120 may interface with the UWBS 130 through the second interface.

Meanwhile, in the disclosure, the UWB-enabled application 110 and/or framework 120 may be implemented by an application processor (AP) (or processor). Accordingly, in the disclosure, the operation of the UWB-enabled application 110 and/or the framework 120 may be understood as performed by an AP (or a processor). In this disclosure, the framework may be referred to as an AP or a processor.

The UWBS 130 may be a hardware component including a UWB MAC Layer and a UWB Physical Layer. The UWBS 130 may perform UWB session management and may communicate with the UWBS of another UWB device. The UWBS 130 may interface with the framework 120 through the second interface and may obtain the secure data from the Secure Component. In an embodiment, the framework (or application processor) 120 may transmit a command to the UWBS 130 through UCI, and the UWBS 130 may transmit a response to the command to the framework 120. The UWBS 130 may transfer a notification to the framework 120 through the UCI.

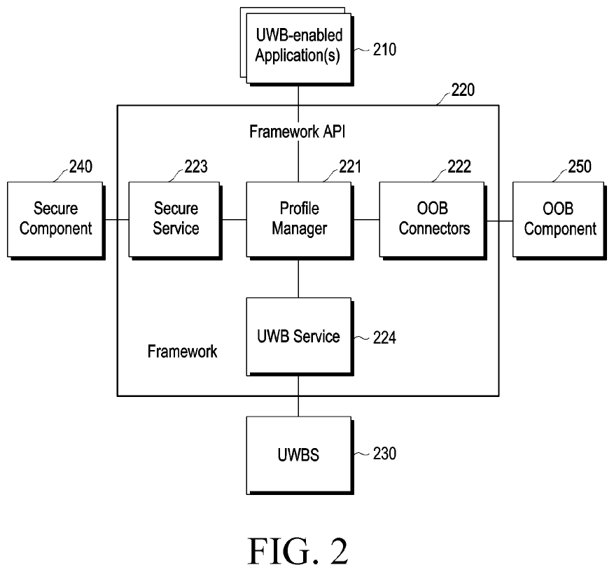

FIG. 2 illustrates an example configuration of a framework of a UWB device according to an embodiment of the disclosure.

The UWB device of FIG. 2 may be an example of the UWB device of FIG. 1.

Referring to FIG. 2, the framework 220 may include, e.g., software components, such as Profile Manager 221, OOB Connector(s) 222, Secure Service 223 and/or UWB service 224.

The Profile Manager 221 may serve to manage profiles available on the UWB device. Profile may be a set of parameters required to establish communication between UWB devices. For example, a profile may include a parameter indicating which OOB secure channel is used, a UWB/OOB configuration parameter, a parameter indicating whether the use of a particular secure component is mandatory, and/or a parameter related to the file structure of the ADF. The UWB-enabled application 210 may communicate with the Profile Manager 221 through the first interface (e.g., framework (API)).

The OOB Connector 222 may serve to establish an OOB connection with another device. The OOB Connector 222 may handle an OOB step including a discovery step and/or a connection step. The OOB component (e.g., BLE component) 250 may be connected to the OOB connector 222.

The Secure Service 223 may play a role of interfacing with a Secure Component 240, such as SE or TEE.

The UWB Service 224 may perform a role of managing the UWBS 230. The UWB Service 224 may provide access to the UWBS 230 from the Profile Manager 221 by implementing the second interface.

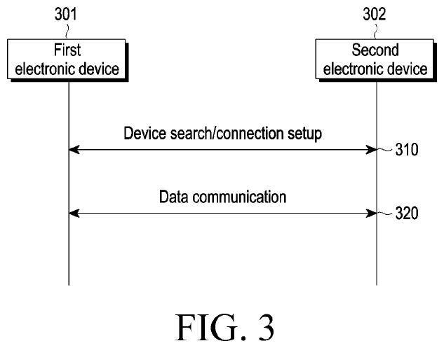

FIG. 3 illustrates a method for performing communication by a plurality of electronic devices according to an embodiment of the disclosure.

The first electronic device 301 and the second electronic device 302 of FIG. 3 may be, e.g., the UWB devices of FIG. 1 or 2.

Referring to FIG. 3, the first electronic device 301 and the second electronic device 302 may perform a device search/connection setup procedure 310 and a data communication procedure 320. The device search/connection setup procedure 310 and data communication procedure 320 may be managed or controlled by the MAC layer (entity) of the electronic device.

### (1) Device Search/Connection Setup Procedure

In the disclosure, the device search/connection setup procedure 310 may be a prior procedure performed before the data communication procedure 320. As an example, the device discovery/connection setup procedure 310 may be performed over OOB communication (channel), NB communication (channel), and/or UWB communication (channel).

The device search/connection setup procedure 310 may include at least one of the following operations.
Device discovery operation: An operation in which the electronic device searches for (discovers) another UWB devices. The device discovery operation may include an operation for transmitting/receiving an advertisement message. In the disclosure, the device discovery operation may be referred to as a discovery operation or an advertising operation.
Connection setup operation: An operation in which two electronic devices establish a connection. The connection setup operation may include an operation for transmitting/receiving a connection request message and a connection confirmation message. A connection (channel) established through the connection setup operation may be used to configure and control a UWB session for data communication. For example, parameters (e.g., UWB performance parameters (Controlee performance parameters), UWB configuration parameters, session key-related parameters) for configuring a UWB session through a secure channel established through the connection setup operation may be negotiated between two electronic devices.

### (2) Data Communication Procedure

In the disclosure, the data communication procedure 320 may be a procedure for transmitting and receiving data using UWB communication. As an embodiment, the data communication procedure may be performed by UWB communication or NB communication.

The data communication procedure 320 may include at least one of the following operations.
UWB ranging operation: An operation in which the electronic device performs UWB ranging with another electronic device in a preset UWB ranging scheme (e.g., OWR, SS-TWR, DS-TWR scheme). As an embodiment, the UWB ranging operation may include a ToF measurement operation and/or an AoA measurement operation.
Transaction operation: An operation in which an electronic device exchanges service data with another electronic device.

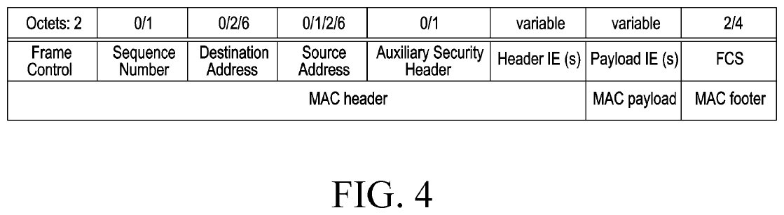

FIG. 4 illustrates a structure of a UWB MAC frame according to an embodiment of the disclosure.

In the embodiment of FIG. 4, the UWB MAC frame may follow the MAC frame structure of IEEE 802.15.4z, for example. In this disclosure, the UWB MAC frame may be simply referred to as a MAC frame or frame. As an embodiment, the UWB MAC frame may be used to transfer UWB data (e.g., UWB message, ranging message, control information, service data, application data, transaction data, etc.).

Referring to FIG. 4, the UWB MAC frame may include a MAC header (MHR), a MAC payload and/or a MAC footer (MFR).

### (1) MAC Header

The MAC header may include a Frame Control field, a Sequence Number field, a Destination Address field, a Source Address field, an Auxiliary Security Header field, and/or at least one Header IE field. According to an embodiment, some fields may not be included in the MAC header.

As an embodiment, the Frame Control field may include a Frame type field, a Security Enabled field, a Frame Pending field, an AR field, a PAN ID Compression field, a Sequence Number Suppression field, an IE present field, a Destination Addressing Mode field, a Frame Version field, and/or a Source Addressing Mode field. Each field is described below.

The Frame Type field may indicate the frame type. As an embodiment, the frame type may include a data type and/or a multipurpose type.

The Security Enabled field may indicate whether an Auxiliary Security Header field exists. The Auxiliary Security Header field may include information required for security processing.

The Frame Pending field may indicate whether the device transmitting the frame has more data for the recipient. In other words, the Frame Pending field may indicate whether there is a pending frame for the recipient.

The AR field may indicate whether acknowledgment for frame reception is required from the recipient.

The PAN ID Compression field may indicate whether the PAN ID field exists.

The Sequence Number Suppression field may indicate whether the Sequence Number field exists. The Sequence Number field may indicate the sequence identifier for the frame.

The IE present field may indicate whether the Header IE field and the Payload IE field are included in the frame.

The Destination Addressing Mode field may indicate whether the Destination Address field may include a short address (e.g., 16 bits) or an extended address (e.g., 64 bits). The Destination Address field may indicate the address of the recipient of the frame.

The Frame Version field may indicate the frame version. For example, the Frame Version field may be set to a value indicating IEEE std 802.15.4z-2020.

The Source Addressing Mode field may indicate whether the Source Address field exists, and if the Source Address field exists, whether the Source Address field includes a short address (e.g., 16 bits) or an extended address (e.g., 64 bits). The Source Address field may indicate the address of the originator of the frame.

### (2) MAC Payload

The MAC payload may include at least one Payload IE field. As an embodiment, the Payload IE field may include a Vendor Specific Nested IE. As an embodiment, the Payload IE field may include the Payload IE field of the UWB message, ranging message or control message.

### (3) MAC Footer

The MAC footer may include an FCS field. The FCS field may include a 16-bit CRC or a 32-bit CRC.

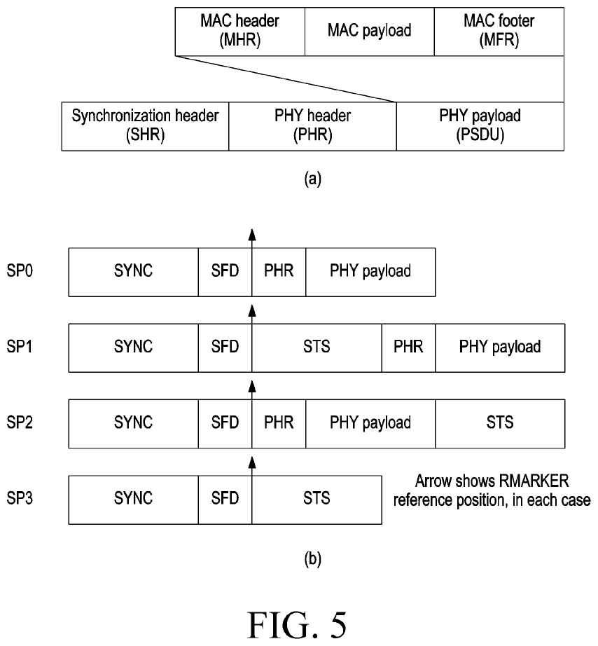

FIG. 5 illustrates a structure of a UWB PHY packet according to an embodiment of the disclosure.

FIG. 5(a) illustrates an example structure of a UWB PHY packet to which the STS packet configuration is not applied, and FIG. 5(b) illustrates an example structure of a UWB PHY packet to which the STS packet configuration is applied. In the disclosure, the UWB PHY packet may be referred to as a PHY packet, a PHY PDU (PPDU), or a frame.

Referring to FIG. 5(a), the PPDU may include a synchronization header (SHR), a PHY header (PHR), and a PHY payload (PSDU). The PSDU may include a MAC frame. As shown in FIG. 4, the MAC frame may include a MAC header (MHR), a MAC payload and/or a MAC footer (MFR). In the disclosure, the synchronization header part may be referred to as a preamble, and the part including the PHY header and the PHY payload may be referred to as a data part.

The synchronization header may be used for synchronization for signal reception and may include a SYNC field and a start-of-frame delimiter (SFD).

The SYNC field may be a field including a plurality of preamble symbols used for synchronization between transmission/reception devices. The preamble symbol may be set through one of previously defined preamble codes.

The SFD field may be a field indicating the end of the SHR and the start of the data field.

The PHY header may provide information about the configuration of the PHY payload. For example, the PHY header may include information about the length of the PSDU, information indicating whether the current frame is an RFRAME, and the like.

Meanwhile, the PHY layer of the UWB device may include an optional mode to provide a reduced on-air time for high density/low power operation. In this case, the UWB PHY packet may include an encrypted sequence (i.e., STS) to increase the integrity and accuracy of the ranging measurement timestamp. An STS may be included in the STS field of the UWB PHY packet and be used for secure ranging.

Referring to FIG. 5(b), in the case of STS packet (SP) setting 0 (SP0), the STS field is not included in the PPDU (SP0 packet). In the case of SP setting 1 (SP1), the STS field is positioned immediately after the Start of Frame Delimiter (SFD) field and before the PHR field (SP1 packet). In the case of SP setting 2 (SP2), the STS field is positioned after the PHY payload (SP2 packet). In the case of SP setting 3 (SP3), the STS field is positioned immediately after the SFD field, and the PPDU does not include the PHR and data field (PHY payload) (SP3 packet). In other words, in the case of SP3, the PPDU does not include the PHR and PHY payload.

In the embodiment of FIG. 5(b), each UWB PHY packet may include RMARKER for defining a reference time. RMARKER may be used to obtain the transmission time, reception time and/or time range of the ranging message (frame) in the UWB ranging procedure.

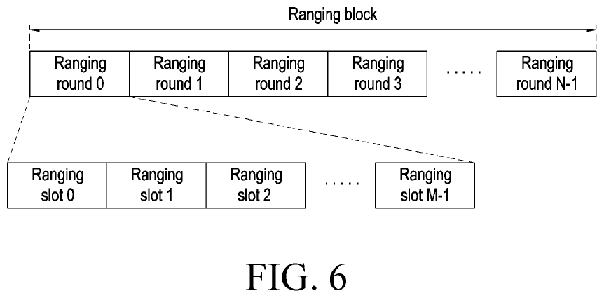

FIG. 6 illustrates an example of a structure of a ranging block and round used for UWB ranging according to an embodiment of the disclosure.

In this disclosure, the ranging block refers to a time period for ranging. The ranging round may be a period of sufficient duration to complete one entire range-measurement cycle (ranging cycle) in which a set of UWB devices participating in a ranging exchange involves. The ranging slot may be a sufficient period for transmission of at least one ranging frame (RFRAME) (e.g., ranging initiation/reply/final message, etc.).

As shown in FIG. 6, one ranging block may include at least one ranging round. Each ranging round may include at least one ranging slot.

When the ranging mode is a block-based mode, a mean time between contiguous ranging rounds may be a constant. Alternatively, when the ranging mode is an interval-based mode, the time between contiguous ranging rounds may be dynamically changed. In other words, the interval-based mode may adopt a time structure having an adaptive spacing.

The number and duration of slots included in the ranging round may be changed between ranging rounds.

In the disclosure, a ranging block, a ranging round, and a ranging slot may be abbreviated as a block, a round, and a slot.

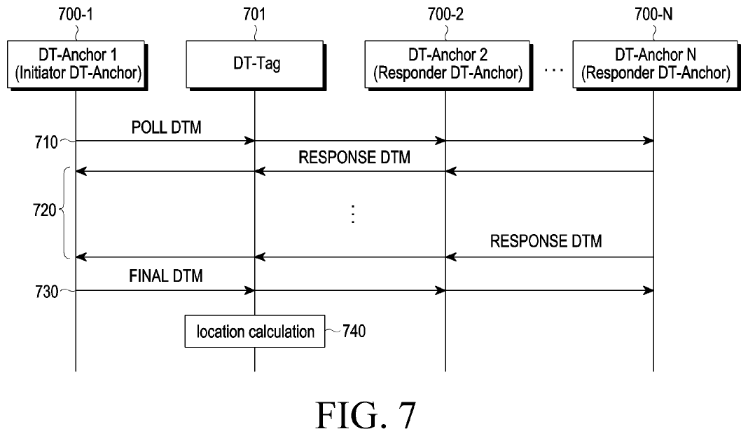

FIG. 7 illustrates schematic operations of a DL-TDoA procedure according to an embodiment of the disclosure.

Referring to FIG. 7, in operation 710, DT anchor 1 700-1, which is an initiator DL-TDoA (DT) anchor, may initiate a DT procedure by transmitting a poll message (Poll DTM).

In operation 720, DT anchor 2 to DT anchor N 700-2, . . . , 700-N, which are responder DT anchors, may transmit a response message (responder DTM). As an example, the responder DT anchor may identify whether a response message may be transmitted and/or a ranging slot used for transmitting the response message, based on scheduling information included in the poll message. As an embodiment, the response message may include information about a first response time B. Here, the first response time may be the time required for the corresponding responder DT anchor to receive the initiation message and transmit a response message corresponding to the initiation message.

In operation 730, DT anchor 1 700-1 may end the DT procedure by transmitting a termination message (final DTM). As an embodiment, the termination message may include information about a second response time γ. Here, the second response time may be the time required for the initiator DT anchor to receive the response message and transmit the termination message.

As shown in FIG. 7, the DT tag 701 may receive (or overhear) the initiation message, the response message, and the end message exchanged between DT anchors 700-1, . . . , 700-N and obtain (find out) a TDoA curve. The DT tag 701 may obtain a TDoA result by repeating the same on the signals received from, e.g., three or more DT anchors.

In operation 740, the DT tag 701 may obtain a relative position to the DT anchor based on the TDoA result.

Listen before talk (LBT) may refer to a method in which a wireless device identifies that a frequency channel is empty before using the frequency channel and then performs transmission using the channel. The LBT may be used to prevent interference or collision between devices using the shared frequency band. The wireless device may measure the frequency channel state before transmitting information through LBT and transmit information only when the channel is empty. In this case, the clear channel assessment (CCA) may be used as a technology for measuring the channel state.

Meanwhile, if local regulations do not impose any restrictions according to the IEEE 802.15.4ab standard, LBT may be applied to all channels. In this case, the wireless device may perform LBT in each slot unit.

However, since the narrow band (NB) of IEEE 802.15.4ab affects the 802.11 operation, a provided technology that allows LBT to be applied unconditionally above a specific duty cycle is being studied, and in this case, UWB devices may lose the transmission opportunity from other devices in each slot and may cause issues with transmission.

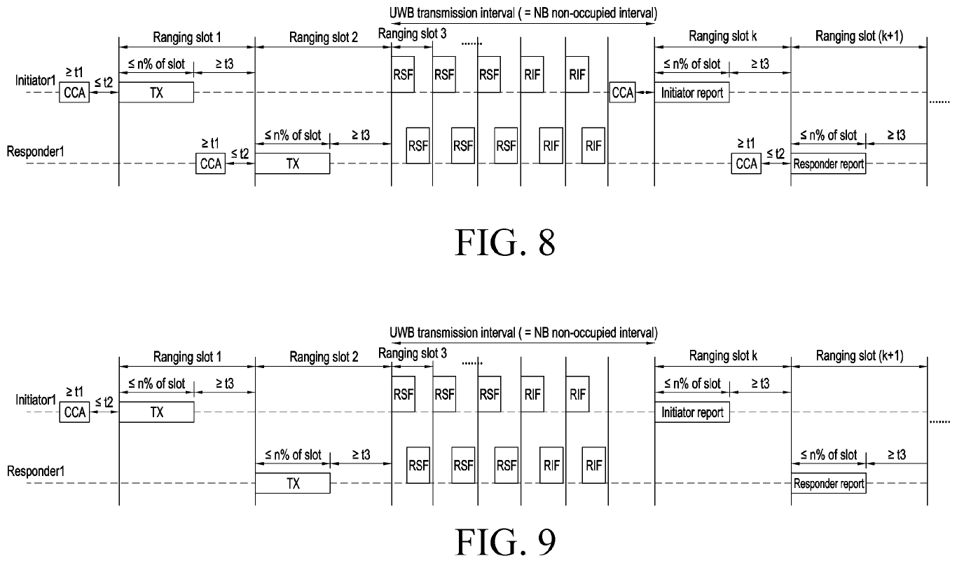

FIG. 8 illustrates an example of performing LBT in each slot unit according to an embodiment of the disclosure.

Referring to FIG. 8, the first UWB device initiator 1 may serve as an initiator during UWB communication, and the second UWB device responder 1 may serve as a responder during UWB communication. Each of the first UWB device initiator 1 and the second UWB device responder 1 may independently apply the LBT protocol for their respective transmission slots even when the same channel is continuously used. Each of the first UWB device initiator 1 and the second UWB device responder 1 may perform message (or frame) transmission after a set time period if it is evaluated that the channel is cleared after the completion of the CCA. According to an embodiment, each of the first UWB device initiator 1 and the second UWB device responder 1 may perform CCA before transmitting a message (or frame) to occupy the narrow band (NB) channel of 802.15.4ab.

The first UWB device initiator 1 may perform CCA for a time longer than or equal to t1 (e.g., 9 us) to measure the channel state. Thereafter, the first UWB device initiator 1 may transmit a message (or a frame) in the first ranging slot 1 after a time of t2 (e.g., 10 us) or less (TX). The first UWB device initiator 1 may transmit a message (or a frame) for a time shorter than or equal to n % (e.g., n=95) of the ranging slot (TX). In the first ranging slot, the first UWB device initiator 1 may be configured not to transmit a message (or frame) for a time longer than or equal to t3 (e.g., 100 us) after transmitting the message (or frame) (TX).

In the first ranging slot, during a time period in which the first UWB device initiator 1 does not transmit a message (or frame), the second UWB device responder 1 may perform CCA for a time longer than or equal to t1 (e.g., 9 us) to measure the channel state. Thereafter, the second UWB device responder 1 may transmit a message (or a frame) in the second ranging slot 1 after a time shorter than or equal to t2 (e.g., 10 us) (TX). The second UWB device responder 1 may transmit a message (or a frame) for a time shorter than or equal to n % (e.g., n=95) of the ranging slot (TX). In the second ranging slot, the second UWB device responder 1 may be configured not to transmit a message (or frame) for a time longer than or equal to t3 (e.g., 100 us) after transmitting the message (or frame) (TX).

Each of the first UWB device initiator 1 and the second UWB device responder 1 may transmit a ranging sequence fragment (RSF) and/or a ranging integrity fragment (RIF) during the UWB transmission period (or the NB non-occupied period).

According to an embodiment, a multi-millisecond (MMS) UWB packet may be used to enhance link budget and ToF accuracy. The MMS UWB packet may be classified into two types: RSF and RIF. Each RSF may include repetition of a selected multi-millisecond ranging sequence (MMRS). Each RIF may transfer the waveform of randomly modulated pulses for ranging integrity based on a 4z design (e.g., STS).

In the UWB transmission period (or the NB non-occupied period), the first UWB device initiator 1 may perform CCA for a time longer than or equal to t1 (e.g., 9 us) to measure the channel state. Thereafter, the first UWB device initiator 1 may transmit the report message (initiator report) in the kth ranging slot after a time of t2 (e.g., 10 us) or less (TX). The first UWB device initiator 1 may transmit a report message (initiator report) for a time shorter than or equal to n % (e.g., n=95) of the ranging slot (TX). In the kth ranging slot, the first UWB device initiator 1 may be configured not to transmit a message (or frame) for a time longer than t3 (e.g., 100 us) after transmitting the report message (initiator report).

In the kth ranging slot k, during a time period in which the first UWB device initiator 1 does not transmit a message (or frame), the second UWB device responder 1 may perform CCA for a time longer than or equal to t1 (e.g., 9 us) to measure the channel state. Thereafter, the second UWB device responder 1 may transmit a report message (responder report) in the k+1th ranging slot (ranging slot k+1) after a time of t2 (e.g., 10 us) or less (TX). The second UWB device responder 1 may transmit a report message (responder report) for a time shorter than or equal to n % (e.g., n=95) of the ranging slot. In the k+1th ranging slot (ranging slot k+1), the second UWB device responder 1 may be configured not to transmit a message (or frame) for a time longer than or equal to t3 (e.g., 100 us) after transmitting the report message (responder report).

For convenience of description, FIG. 8 illustrates an example in which the first UWB device initiator 1 transmits a report message (initiator report) in the kth ranging slot (ranging slot k) and the second UWB device responder 1 transmits a report message (responder report) in the k+1th ranging slot (ranging slot k+1). According to an embodiment, the first UWB device initiator 1 may not transmit a report message (initiator report transmission) in the kth ranging slot (ranging slot k). According to an embodiment, the second UWB device responder 1 may not transmit a report message (responder report) in the k+1th ranging slot (ranging slot k+1). According to an embodiment, at least one of the report message (initiator report transmission) and the report message (responder report) may be transmitted.

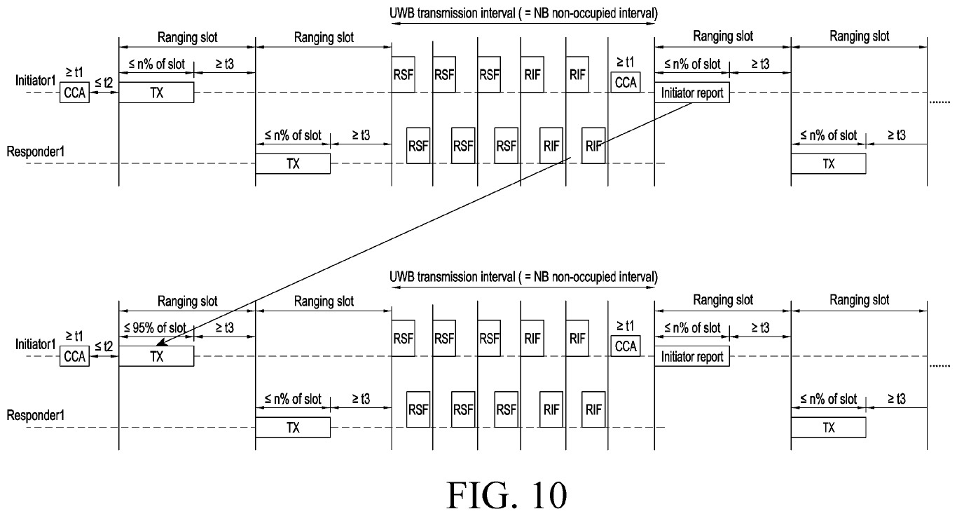

FIG. 9 illustrates an example of performing one LBT for a plurality of slots according to an embodiment of the disclosure.

In the embodiment of FIG. 8, a plurality of LBT operations for TX are performed in each slot unit, but in the embodiment of FIG. 9, one LBT operation for a plurality of slots may be performed.

Referring to FIG. 9, the first UWB device initiator 1 may serve as an initiator during UWB communication, and the second UWB device responder 1 may serve as a responder during UWB communication. Each of the first UWB device initiator 1 and the second UWB device responder 1 may independently apply the LBT protocol for their respective transmission slots even when the same channel is continuously used. Each of the first UWB device initiator 1 and the second UWB device responder 1 may perform message (or frame) transmission after a set time period if it is evaluated that the channel is cleared after the completion of the CCA. According to an embodiment, each of the first UWB device initiator 1 and the second UWB device responder 1 may perform CCA before transmitting a message (or frame) to occupy the narrow band (NB) channel of 802.15.4ab.

The first UWB device initiator 1 may perform CCA for a time longer than or equal to t1 (e.g., 9 us) to measure the channel state. The first UWB device initiator 1 may perform LBT only once without performing LBT in every slot. Thereafter, the first UWB device initiator 1 may transmit a message (or a frame) in the first ranging slot 1 after a time of t2 (e.g., 10 us) or less (TX). The first UWB device initiator 1 may transmit a message (or a frame) for a time shorter than or equal to n % (e.g., n=95) of the ranging slot (TX). In the first ranging slot, the first UWB device initiator 1 may be configured not to transmit a message (or frame) for a time longer than or equal to t3 (e.g., 100 us) after transmitting the message (or frame) (TX).

During a time period in which the first UWB device initiator 1 does not transmit a message (or frame) in the first ranging slot, the second UWB device responder 1 may not perform CCA. In the second ranging slot, the second UWB device responder 1 may transmit a message (or a frame) for a time shorter than or equal to n % (e.g., n=95) of the ranging slot (TX). In the second ranging slot, the second UWB device responder 1 may be configured not to transmit a message (or frame) for a time longer than or equal to t3 (e.g., 100 us) after transmitting the message (or frame) (TX).

Each of the first UWB device initiator 1 and the second UWB device responder 1 may transmit a ranging sequence fragment (RSF) and/or a ranging integrity fragment (RIF) during the UWB transmission period (or the NB non-occupied period).

In the UWB transmission period (or the NB non-occupied period), the first UWB device initiator 1 may not perform CCA. In the kth ranging slot (ranging slot k), the first UWB device initiator 1 may transmit a report message (initiator report). The first UWB device initiator 1 may transmit the report message (initiator report) for a time shorter than or equal to n % (e.g., n=95) of the ranging slot. In the kth ranging slot (ranging slot k), the first UWB device initiator 1 may be configured not to transmit a message (or frame) for a time longer than or equal to t3 (e.g., 100 us) after transmitting the report message (initiator report).

In the kth ranging slot (ranging slot k), during a time period in which the first UWB device initiator 1 does not transmit a message (or frame), the second UWB device responder 1 may not perform CCA. The second UWB device responder 1 may transmit a report message (responder report) in the k+1th ranging slot (ranging slot k+1). The second UWB device responder 1 may transmit a report message (responder report) for a time shorter than or equal to n % (e.g., n=95) of the ranging slot. In the k+1th ranging slot (ranging slot k+1), the second UWB device responder 1 may be configured not to transmit a message (or frame) for a time longer than or equal to t3 (e.g., 100 us) after transmitting the report message (responder report).

For convenience of description, FIG. 9 illustrates an example in which the first UWB device initiator 1 transmits a report message (initiator report) in the kth ranging slot (ranging slot k) and the second UWB device responder 1 transmits a report message (responder report) in the k+1th ranging slot (ranging slot k+1). According to an embodiment, the first UWB device initiator 1 may not transmit a report message (initiator report transmission) in the kth ranging slot (ranging slot k). According to an embodiment, the second UWB device responder 1 may not transmit a report message (responder report) in the k+1th ranging slot (ranging slot k+1). According to an embodiment, at least one of the report message (initiator report transmission) and the report message (responder report) may be transmitted.

According to an embodiment, the first UWB device initiator 1 may perform one CCA for a set number of ranging slots. For convenience of description, FIG. 9 illustrates an example in which the first UWB device initiator 1 performs CCA before the first ranging slot, and the first UWB device initiator 1 and the second UWB device responder 1 do not perform CCA from the first ranging slot to the k+1th ranging slot. However, the technical spirit of the disclosure is not limited thereto, and the first UWB device initiator 1 may perform one CCA for various numbers of ranging slots.

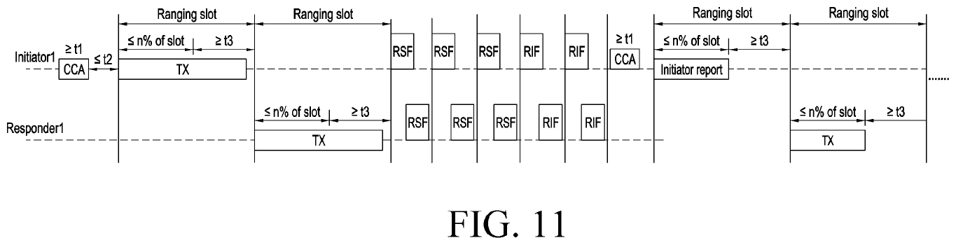

FIG. 10 illustrates an example of performing round level LBT according to an embodiment of the disclosure.

Referring to FIG. 10, the first UWB device initiator 1 may perform CCA for a time longer than or equal to t1 (e.g., 9 us) to measure the channel state. The first UWB device initiator 1 may perform LBT only once without performing LBT in every slot. Thereafter, the first UWB device initiator 1 may transmit a message (or a frame) in the first ranging slot 1 after a time of t2 (e.g., 10 us) or less (TX). The first UWB device initiator 1 may transmit a message (or a frame) for a time shorter than or equal to n % (e.g., n=95) of the ranging slot (TX). In the first ranging slot, the first UWB device initiator 1 may be configured not to transmit a message (or frame) for a time longer than or equal to t3 (e.g., 100 us) after transmitting the message (or frame) (TX).

During a time period in which the first UWB device initiator 1 does not transmit a message (or frame) in the first ranging slot, the second UWB device responder 1 may not perform CCA. In the second ranging slot, the second UWB device responder 1 may transmit a message (or a frame) for a time shorter than or equal to n % (e.g., n=95) of the ranging slot (TX). In the second ranging slot, the second UWB device responder 1 may be configured not to transmit a message (or frame) for a time longer than or equal to t3 (e.g., 100 us) after transmitting the message (or frame) (TX).

Each of the first UWB device initiator 1 and the second UWB device responder 1 may transmit a ranging sequence fragment (RSF) and/or a ranging integrity fragment (RIF) during the UWB transmission period (or the NB non-occupied period). In the UWB transmission period (or the NB non-occupied period), the first UWB device initiator 1 may perform CCA for a time longer than or equal to t1 (e.g., 9 us) to measure the channel state.

In the next ranging slot (ranging slot k), the first UWB device initiator 1 may transmit a report message (initiator report). The first UWB device initiator 1 may transmit the report message (initiator report) for a time shorter than or equal to n % (e.g., n=95) of the ranging slot. In the corresponding ranging slot, the first UWB device initiator 1 may be configured not to transmit a message (or frame) for a time longer than or equal to t3 (e.g., 100 us) after transmitting the report message (initiator report). In the corresponding ranging slot, during a time period in which the first UWB device initiator 1 does not transmit a message (or frame), the second UWB device responder 1 may not perform CCA.

The second UWB device responder 1 may transmit a report message (responder report) in the next ranging slot. The second UWB device responder 1 may transmit a report message (responder report) for a time shorter than or equal to n % (e.g., n=95) of the ranging slot. In the corresponding ranging slot, the second UWB device responder 1 may be configured not to transmit a message (or frame) for a time longer than or equal to t3 (e.g., 100 us) after transmitting the report message (responder report).

Thereafter, the first UWB device initiator 1 and/or the second UWB device responder 1 may perform the same operations in the next ranging round. According to an embodiment, the first UWB device initiator 1 may perform CCA once in each ranging round.

For convenience of description, FIG. 10 illustrates an example in which the first UWB device initiator 1 transmits a report message (initiator report transmission) and the second UWB device responder 1 transmits a report message (responder report). According to an embodiment, the first UWB device 1 may not transmit a report message (initiator report transmission) in the ranging slot. According to an embodiment, the second UWB device responder 1 may not transmit a report message (responder report) in the ranging slot. According to an embodiment, at least one of the report message (initiator report transmission) and the report message (responder report) may be transmitted.

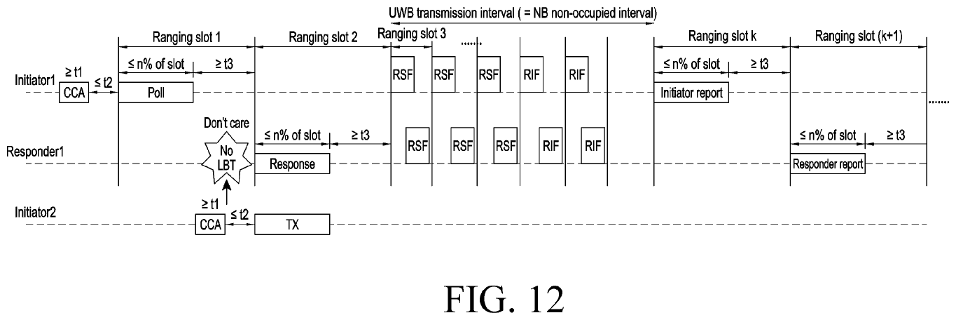

FIG. 11 illustrates another example of performing round level LBT according to an embodiment of the disclosure.

Referring to FIG. 11, the first UWB device initiator 1 may perform CCA for a time longer than or equal to t1 (e.g., 9 us) to measure the channel state. The first UWB device initiator 1 may perform LBT only once without performing LBT in every slot. Thereafter, the first UWB device initiator 1 may transmit a message (or a frame) in the first ranging slot 1 after a time of t2 (e.g., 10 us) or less (TX). The first UWB device initiator 1 may transmit a message (or a frame) for a time period exceeding n % (e.g., n=95) of the ranging slot (TX).

In the second ranging slot, the second UWB device responder 1 may transmit a message (or a frame) for a time exceeding n % (e.g., n=95) of the ranging slot (TX).

Each of the first UWB device initiator 1 and the second UWB device responder 1 may transmit a ranging sequence fragment (RSF) and/or a ranging integrity fragment (RIF) during the UWB transmission period (or the NB non-occupied period). In the UWB transmission period (or the NB non-occupied period), the first UWB device initiator 1 may perform CCA for a time longer than or equal to t1 (e.g., 9 us) to measure the channel state.

In the next ranging slot, the first UWB device initiator 1 may transmit a report message (initiator report). The first UWB device initiator 1 may transmit a report message (initiator report) for a time period exceeding n % (e.g., n=95) of the ranging slot.

The second UWB device responder 1 may transmit a report message (responder report) in the next ranging slot. The second UWB device responder 1 may transmit a report message (responder report) for a time period exceeding n % (e.g., n=95) of the ranging slot.

For convenience of description, FIG. 11 illustrates an example in which the first UWB device initiator 1 transmits a report message (initiator report transmission) and the second UWB device responder 1 transmits a report message (responder report). According to an embodiment, the first UWB device 1 may not transmit a report message (initiator report transmission) in the ranging slot. According to an embodiment, the second UWB device responder 1 may not transmit a report message (responder report) in the ranging slot. According to an embodiment, at least one of the report message (initiator report transmission) and the report message (responder report) may be transmitted.

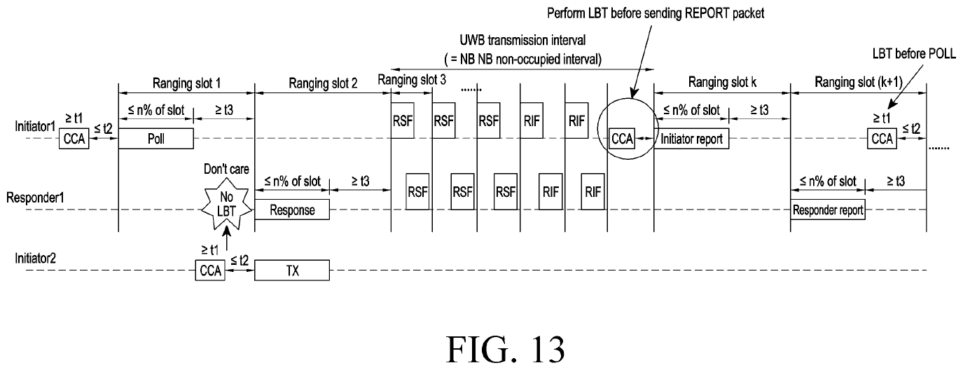

FIG. 12 illustrates an example of performing LBT before transmitting a POLL message according to an embodiment of the disclosure.

There may be a need for a method for preventing LBT from being attempted in each slot to enable continuous transmission as much as possible without losing the transmission opportunity (or authority) due to unnecessary interruption in transmission caused by other devices. FIG. 12 provides a method for maintaining the channel usage authority during one ranging round when the channel usage authority is obtained through the LBT. According to an embodiment, the first UWB device initiator 1 may not perform additional LBT during the corresponding ranging round regardless of whether another device (e.g., initiator 2) performs transmission.

Referring to FIG. 12, the first UWB device initiator 1 may serve as an initiator during UWB communication, the second UWB device responder 1 may serve as a responder during UWB communication, and the third UWB device initiator 2 may serve as another initiator during UWB communication.

Within the ranging round, the first UWB device initiator 1 may perform CCA for a time longer than or equal to t1 (e.g., 9 us) to measure the channel state. The first UWB device initiator 1 may perform LBT only once before transmitting a POLL message without performing LBT in each slot within the ranging round. Thereafter, the first UWB device initiator 1 may transmit a POLL message in the first ranging slot (ranging slot 1) after a time shorter than or equal to t2 (e.g., 10 us). The first UWB device initiator 1 may transmit a POLL message for a time shorter than or equal to n % (e.g., n=95) of the ranging slot. In the first ranging slot, the first UWB device initiator 1 may be configured not to transmit a message (or frame) for a time longer than or equal to t3 (e.g., 100 us) after transmitting the POLL message.

In the first ranging slot, during a time period in which the first UWB device initiator 1 does not transmit a message (or frame), the third UWB device initiator 2 may perform CCA. The second UWB device responder 1 may not perform the LBT operation regardless of the CCA operation of the third UWB device initiator 2.

In the second ranging slot, the second UWB device responder 1 may transmit a response message for a time shorter than or equal to n % (e.g., n=95) of the ranging slot. In the second ranging slot, the second UWB device responder 1 may be configured not to transmit a message (or frame) for a time longer than or equal to t3 (e.g., 100 us) after transmitting the response message.

Each of the first UWB device initiator 1 and the second UWB device responder 1 may transmit a ranging sequence fragment (RSF) and/or a ranging integrity fragment (RIF) during the UWB transmission period (or the NB non-occupied period).

In the UWB transmission period (or the NB non-occupied period), the first UWB device initiator 1 may not perform CCA. In the kth ranging slot (ranging slot k), the first UWB device initiator 1 may transmit a report message (initiator report). The first UWB device initiator 1 may transmit the report message (initiator report) for a time shorter than or equal to n % (e.g., n=95) of the ranging slot. In the kth ranging slot (ranging slot k), the first UWB device initiator 1 may be configured not to transmit a message (or frame) for a time longer than or equal to t3 (e.g., 100 us) after transmitting the report message (initiator report).

In the kth ranging slot (ranging slot k), during a time period in which the first UWB device initiator 1 does not transmit a message (or frame), the second UWB device responder 1 may not perform CCA. The second UWB device responder 1 may transmit a report message (responder report) in the k+1th ranging slot (ranging slot k+1). The second UWB device responder 1 may transmit a report message (responder report) for a time shorter than or equal to n % (e.g., n=95) of the ranging slot. In the k+1th ranging slot (ranging slot k+1), the second UWB device responder 1 may be configured not to transmit a message (or frame) for a time longer than or equal to t3 (e.g., 100 us) after transmitting the report message (responder report).

For convenience of description, FIG. 12 illustrates an example in which the first UWB device initiator 1 transmits a report message (initiator report transmission) and the second UWB device responder 1 transmits a report message (responder report). According to an embodiment, the first UWB device 1 may not transmit a report message (initiator report transmission) in the ranging slot. According to an embodiment, the second UWB device responder 1 may not transmit a report message (responder report) in the ranging slot. According to an embodiment, at least one of the report message (initiator report transmission) and the report message (responder report) may be transmitted.

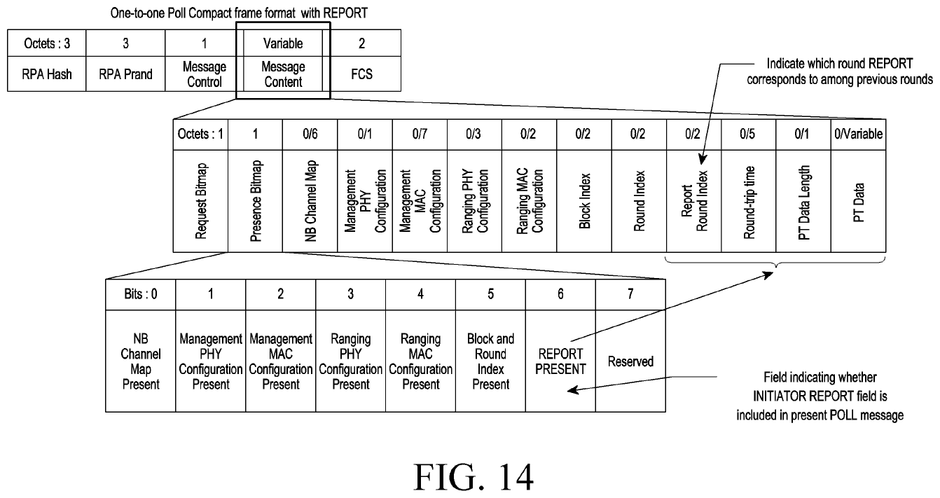

FIG. 13 illustrates an example of performing LBT before transmitting a POLL message and a report message according to an embodiment of the disclosure.

FIG. 13 provides a method of performing LBT CCA once more before the REPORT phase, as it may have lost occupancy of the channel when the NB is not occupied in the UWB transmission period while maintaining the channel usage authority during one ranging round when obtaining the channel usage authority through the first LBT.

Referring to FIG. 13, the first UWB device initiator 1 may serve as an initiator during UWB communication, the second UWB device responder 1 may serve as a responder during UWB communication, and the third UWB device initiator 2 may serve as another initiator during UWB communication.

Within the ranging round, the first UWB device initiator 1 may perform CCA for a time longer than or equal to t1 (e.g., 9 us) to measure the channel state. The first UWB device initiator 1 may perform LBT only once before transmitting a POLL message without performing LBT in each slot within the ranging round. Thereafter, the first UWB device initiator 1 may transmit a POLL message in the first ranging slot (ranging slot 1) after a time shorter than or equal to t2 (e.g., 10 us). The first UWB device initiator 1 may transmit a POLL message for a time shorter than or equal to n % (e.g., n=95) of the ranging slot. In the first ranging slot, the first UWB device initiator 1 may be configured not to transmit a message (or frame) for a time longer than or equal to t3 (e.g., 100 us) after transmitting the POLL message.

In the first ranging slot, during a time period in which the first UWB device initiator 1 does not transmit a message (or frame), the third UWB device initiator 2 may perform CCA. The second UWB device responder 1 may not perform the LBT operation regardless of the CCA operation of the third UWB device initiator 2.

In the second ranging slot, the second UWB device responder 1 may transmit a response message for a time shorter than or equal to n % (e.g., n=95) of the ranging slot. In the second ranging slot, the second UWB device responder 1 may be configured not to transmit a message (or frame) for a time longer than or equal to t3 (e.g., 100 us) after transmitting the response message.

Each of the first UWB device initiator 1 and the second UWB device responder 1 may transmit a ranging sequence fragment (RSF) and/or a ranging integrity fragment (RIF) during the UWB transmission period (or the NB non-occupied period). The first UWB device initiator 1 may perform CCA before transmitting a REPORT packet in the UWB transmission period (or the NB non-occupied period).

When it is determined that the channel is clear as a result of the CCA, the first UWB device initiator 1 may transmit a report message (initiator report) in the kth ranging slot (ranging slot k). The first UWB device initiator 1 may transmit the report message (initiator report) for a time shorter than or equal to n % (e.g., n=95) of the ranging slot. In the kth ranging slot (ranging slot k), the first UWB device initiator 1 may be configured not to transmit a message (or frame) for a time longer than or equal to t3 (e.g., 100 us) after transmitting the report message (initiator report).

The second UWB device responder 1 may transmit a report message (responder report) in the k+1th ranging slot (ranging slot k+1). The second UWB device responder 1 may transmit a report message (responder report) for a time shorter than or equal to n % (e.g., n=95) of the ranging slot. In the k+1th ranging slot (ranging slot k+1), the second UWB device responder 1 may be configured not to transmit a message (or frame) for a time longer than or equal to t3 (e.g., 100 us) after transmitting the report message (responder report). In the k+1th ranging slot (k+1), the first UWB device initiator 1 may perform CCA for a time of t1 (e.g., 9 us) or more to measure the channel state before transmitting the POLL message.

For convenience of description, FIG. 13 illustrates an example in which the first UWB device initiator 1 transmits a report message (initiator report transmission) and the second UWB device responder 1 transmits a report message (responder report). According to an embodiment, the first UWB device 1 may not transmit a report message (initiator report transmission) in the ranging slot. According to an embodiment, the second UWB device responder 1 may not transmit a report message (responder report) in the ranging slot. According to an embodiment, at least one of the report message (initiator report transmission) and the report message (responder report) may be transmitted.

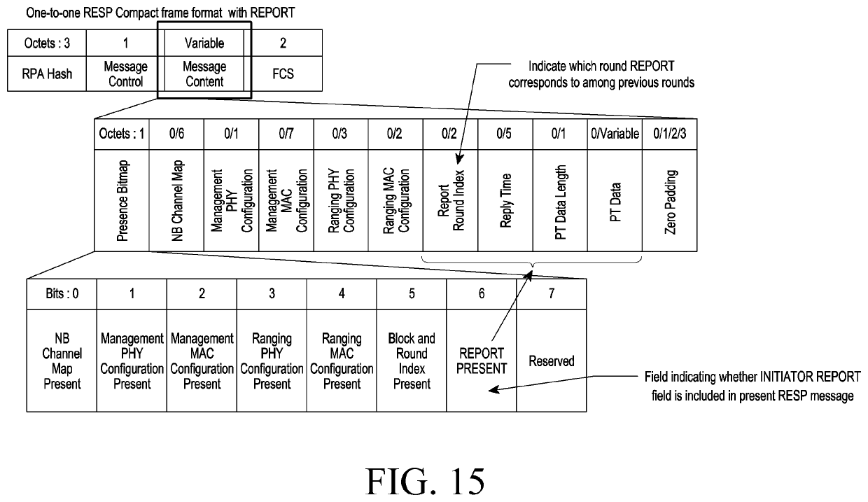

FIG. 14 illustrates an example of a POLL message format according to an embodiment of the disclosure.

The POLL message format illustrated in FIG. 14 may be a one-to-one poll compact frame format. The UWB device serving as an initiator may transmit a one-to-one poll compact frame during a control phase. The one-to-one poll compact frame may enable carrier coherent transmission from the initiator to the responder. According to an embodiment, the one-to-one poll compact frame may include short term operating parameters.

Each of the fields in the POLL message format (or one-to-one poll compact format) illustrated in FIG. 14 may be the same as or substantially the same as that defined in the IEEE 802.15.4ab standard.

According to an embodiment, if the initiator device fails to transmit a report message due to the transmission of another device, the initiator device may piggyback and transmit the ranging report result (or INITIATOR REPORT field) on the POLL signal of the next ranging round.

Referring to FIG. 14, the POLL message format (or one-to-one poll compact frame format) may include an RPA Hash field, an RPA prand field, a message control field, a message content field, and an FCS field.

Referring to FIG. 14, the message content field may include a request bitmap field, a presence bitmap field, an NB channel map field, a management PHY configuration field, a management MAC configuration field, a ranging PHY configuration field, a ranging MAC configuration field, a block index field, a round index field, a report round index field, a round-trip time field, a PT data length field, and a PT data field.

According to an embodiment, the ranging report result (or INITIATOR REPORT field) piggybacked and transmitted on the POLL signal may include a report round index field, a round-trip time field, a PT data length field, and a PT data field. According to an embodiment, the report round index field may indicate which round the ranging report result piggybacked and transmitted on the POLL signal corresponds to among the previous rounds. According to an embodiment, the round-trip time field may indicate the Round-trip time according to the ranging result. According to an embodiment, the PT data length field may indicate the length of the PT data field. According to an embodiment, the PT data field may be a variable-length data field transferred to the next higher layer.

Referring to FIG. 14, the presence bitmap field may include an NB channel map present field, a management PHY configuration present field, a management MAC configuration present field, a ranging PHY configuration present field, a ranging MAC configuration present field, a block and round index present field, a REPORT PRESENT field, and a reserved field.

According to an embodiment, the REPORT PRESENT field in the presence bitmap field may indicate whether a ranging report result (or INITIATOR REPORT field) is included in the corresponding POLL message.

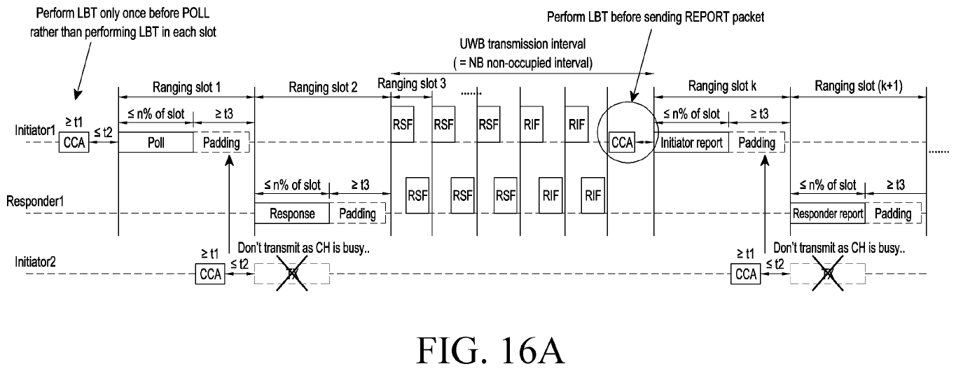

FIG. 15 illustrates an example of a response message format according to an embodiment of the disclosure.

The response message format illustrated in FIG. 15 may be a one-to-one RESP compact frame format. The UWB device serving as a responder may transmit the one-to-one RESP compact frame format to the initiator in response to the POLL message.

According to an embodiment, if the responder device fails to transmit a report message due to transmission of another device, the responder device may piggyback and transmit the ranging report result (or responder REPORT field) on the response signal RESP of the next ranging round.

Each of the fields in the response message format (or one-to-one RESP compact frame format) illustrated in FIG. 15 may be the same as or substantially the same as that defined in the IEEE 802.15.4ab standard.

Referring to FIG. 15, the response message format (or one-to-one RESP compact frame format) may include an RPA Hash field, a Message Control field, a Message Content field, and an FCS field.

Referring to FIG. 15, the Message Content field may include a presence bitmap field, an NB channel map field, a management PHY configuration field, a management MAC configuration field, a ranging PHY configuration field, a ranging MAC configuration field, a report round index field, a reply time field, a PT data length field, and a PT data field.

According to an embodiment, the ranging report result (or responder REPORT field) piggybacked and transmitted on the response signal may include a report round index field, a reply time field, a PT data length field, and a PT data field. According to an embodiment, the report round index field may indicate which round the ranging report result piggybacked and transmitted on the response signal corresponds to among the previous rounds. According to an embodiment, the reply time field may indicate the reply time according to the ranging result. According to an embodiment, the PT data length field may indicate the length of the PT data field. According to an embodiment, the PT data field may be a variable-length data field transferred to the next higher layer.

Referring to FIG. 15, the presence bitmap field may include an NB channel map present field, a management PHY configuration present field, a management MAC configuration present field, a ranging PHY configuration present field, a ranging MAC configuration present field, a block and round index present field, a REPORT PRESENT field, and a reserved field.

According to an embodiment, the REPORT PRESENT field in the presence bitmap field may indicate whether a ranging report result (or a responder REPORT field) is included in the corresponding response message.

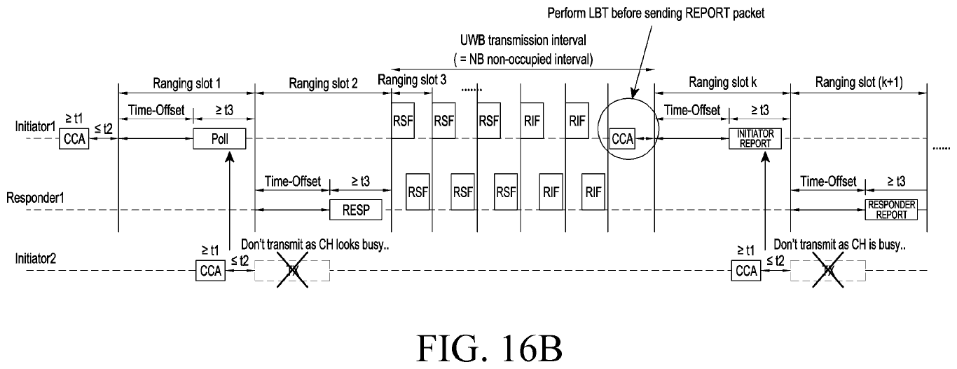

FIG. 16A illustrates another example of performing LBT before transmitting a POLL message and a report message according to an embodiment of the disclosure.

FIG. 16A provides a method of performing LBT CCA once more before the REPORT phase, as it may have lost occupancy of the channel when the NB is not occupied in the UWB transmission period while maintaining the channel usage authority during one ranging round when obtaining the channel usage authority through the first LBT.

Referring to FIG. 16A, the first UWB device initiator 1 may serve as an initiator during UWB communication, the second UWB device responder 1 may serve as a responder during UWB communication, and the third UWB device initiator 2 may serve as another initiator during UWB communication. The first UWB device initiator 1 may transmit a padding signal to determine that the channel is busy in the LBT CCA period of the third UWB device initiator 2 to prevent the possibility of an influence by a collision during transmission of the third UWB device initiator 2.

Within the ranging round, the first UWB device initiator 1 may perform CCA for a time longer than or equal to t1 (e.g., 9 us) to measure the channel state. The first UWB device initiator 1 may perform LBT only once before transmitting a POLL message without performing LBT in each slot within the ranging round. Thereafter, the first UWB device initiator 1 may transmit a POLL message in the first ranging slot (ranging slot 1) after a time shorter than or equal to t2 (e.g., 10 us). The first UWB device initiator 1 may transmit a POLL message for a time shorter than or equal to n % (e.g., n=95) of the ranging slot. In the first ranging slot, the first UWB device initiator 1 may transmit a padding signal for a time within t3 (e.g., 100 us) after transmitting the POLL message.

In the first ranging slot, in the time period when the first UWB device initiator 1 transmits the padding signal, the third UWB device initiator 2 may perform CCA. The third UWB device initiator 2 may detect the padding signal transmitted by the first UWB device initiator land determine that the corresponding channel is busy as a result of CCA, and may not perform message transmission.

In the second ranging slot, the second UWB device responder 1 may transmit a response message for a time shorter than or equal to n % (e.g., n=95) of the ranging slot. In the second ranging slot, the second UWB device responder 1 may transmit a padding signal for a time within t3 (e.g., 100 us) after transmitting the response message.

Each of the first UWB device initiator 1 and the second UWB device responder 1 may transmit a ranging sequence fragment (RSF) and/or a ranging integrity fragment (RIF) during the UWB transmission period (or the NB non-occupied period). The first UWB device initiator 1 may perform CCA before transmitting a REPORT packet in the UWB transmission period (or the NB non-occupied period).

When it is determined that the channel is clear as a result of the CCA, the first UWB device initiator 1 may transmit a report message (initiator report) in the kth ranging slot (ranging slot k). The first UWB device initiator 1 may transmit the report message (initiator report) for a time shorter than or equal to n % (e.g., n=95) of the ranging slot. In the kth ranging slot (ranging slot k), the first UWB device initiator 1 may transmit a padding signal for a time within t3 (e.g., 100 us) after transmitting the report message (initiator report).

In the kth ranging slot (ranging slot k), in the time period when the first UWB device initiator 1 transmits the padding signal, the third UWB device initiator 2 may perform CCA. The third UWB device initiator 2 may detect the padding signal transmitted by the first UWB device initiator land determine that the corresponding channel is busy as a result of CCA, and may not perform message transmission.

The second UWB device responder 1 may transmit a report message (responder report) in the k+1th ranging slot (ranging slot k+1). The second UWB device responder 1 may transmit a report message (responder report) for a time shorter than or equal to n % (e.g., n=95) of the ranging slot. In the k+1th ranging slot (ranging slot k+1), the second UWB device responder 1 may transmit a padding signal for a time within t3 (e.g., 100 us) after transmitting the report message (responder report).

FIG. 16B illustrates another example of performing LBT before transmitting a POLL message and a report message according to an embodiment of the disclosure.

FIG. 16B provides a method of performing LBT CCA once more before the REPORT phase, as it may have lost occupancy of the channel when the NB is not occupied in the UWB transmission period while maintaining the channel usage authority during one ranging round when obtaining the channel usage authority through the first LBT.

Referring to FIG. 16B, the first UWB device initiator 1 may serve as an initiator during UWB communication, the second UWB device responder 1 may serve as a responder during UWB communication, and the third UWB device initiator 2 may serve as another initiator during UWB communication. The first UWB device initiator 1 may delay the transmission of a message (e.g., Poll message) by a time offset to determine that the channel is busy in the LBT CCA period of the third UWB device initiator 2 to prevent the possibility of an influence by a collision during transmission of the third UWB device initiator 2.

Within the ranging round, the first UWB device initiator 1 may perform CCA for a time longer than or equal to t1 (e.g., 9 us) to measure the channel state. The first UWB device initiator 1 may perform LBT before transmitting a POLL message without performing LBT in each slot within the ranging round. Thereafter, the first UWB device initiator 1 may transmit a POLL message in the first ranging slot (ranging slot 1) after a time shorter than or equal to t2 (e.g., 10 us). The first UWB device initiator 1 may transmit a POLL message for a time within t3 (e.g., 100 us) after the first time offset at the start time of the first ranging slot (ranging slot 1).

In the first ranging slot, in the time period when the first UWB device initiator 1 transmits the POLL message, the third UWB device initiator 2 may perform CCA. The third UWB device initiator 2 may detect the POLL message transmitted by the first UWB device initiator 1 and determine that the corresponding channel is busy as a result of CCA, and may not perform message transmission.

The second UWB device responder 1 may transmit a RESP message for a time within t3 (e.g., 100 us) after the second time offset at the start time of the second ranging slot (ranging slot 2). According to an embodiment, the second time offset may be set to be the same as the first time offset. According to an embodiment, the second time offset may be set to be different from the first time offset.

Each of the first UWB device initiator 1 and the second UWB device responder 1 may transmit an RSF and/or an RIF during the UWB transmission period (or the NB non-occupied period). The first UWB device initiator 1 may perform CCA before transmitting a REPORT packet in the UWB transmission period (or the NB non-occupied period).

If it is determined that the channel is clear as a result of the CCA, the first UWB device initiator 1 in the kth ranging slot (ranging slot k) may transmit a report message (initiator report) for a time within t3 (e.g., 100 us) after the first time offset at the start time of the kth ranging slot.

In the kth ranging slot, in the time period when the first UWB device initiator 1 transmits a report message (initiator report), the third UWB device initiator 2 may perform CCA. The third UWB device initiator 2 may detect the report message (initiator report) transmitted by the first UWB device initiator 1 and determine that the corresponding channel is busy as a result of CCA, and may not perform message transmission.

The second UWB device responder 1 in the k+1th ranging slot (ranging slot k+1) may transmit a report message (responder report) for a time within t3 (e.g., 100 us) after the second time offset at the start time of the k+1th ranging slot. For convenience of description, FIGS. 16A and 16B illustrate an example in which the first UWB device initiator 1 transmits a report message (initiator report transmission) and the second UWB device responder 1 transmits a report message (responder report). According to an embodiment, the first UWB device 1 may not transmit a report message (initiator report transmission) in the ranging slot. According to an embodiment, the second UWB device responder 1 may not transmit a report message (responder report) in the ranging slot. According to an embodiment, at least one of the report message (initiator report transmission) and the report message (responder report) may be transmitted.

FIG. 16C illustrates another example of performing LBT before transmitting a POLL message and a report message according to an embodiment of the disclosure.

FIG. 16C provides a method of performing LBT CCA once more before the REPORT phase, as it may have lost occupancy of the channel when the NB is not occupied in the UWB transmission period while maintaining the channel usage authority during one ranging round when obtaining the channel usage authority through the first LBT.

Referring to FIG. 16C, the first UWB device initiator 1 may serve as an initiator during UWB communication, the second UWB device responder 1 may serve as a responder during UWB communication, and the third UWB device initiator 2 may serve as another initiator during UWB communication. The first UWB device initiator 1 may delay the transmission of a message (e.g., Poll message) by a time offset Time offset_1 to determine that the channel is busy in the LBT CCA period of the third UWB device initiator 2 to prevent the possibility of an influence by a collision during transmission of the third UWB device initiator 2.

At the start time of the first ranging slot ranging slot 1 within the ranging round, the first UWB device initiator 1 may perform CCA for a time longer than or equal to t1 (e.g., 9 us) to measure the channel state. The first UWB device initiator 1 may perform LBT before transmitting a POLL message without performing LBT in each slot within the ranging round. If it is determined that the channel is clear as a result of the CCA, in the same first ranging slot, the first UWB device initiator 1 may transmit a POLL message after a time of t2 (e.g., 10 us) or less elapses after the completion of the CCA. The first UWB device initiator 1 may transmit a POLL message for a time within t3 (e.g., 100 us) after the first time offset Time-offset_1 from the start time of the first ranging slot. According to an embodiment, the first UWB device initiator 1 may transmit the POLL message for a time set so that the remaining time in the first ranging slot is t4 or more after transmitting the POLL message.

In the first ranging slot, in the time period when the first UWB device initiator 1 transmits the POLL message, the third UWB device initiator 2 may perform CCA. The third UWB device initiator 2 may detect the POLL message transmitted by the first UWB device initiator 1 and determine that the corresponding channel is busy as a result of CCA, and may not perform message transmission.

The second UWB device responder 1 may transmit a RESP message for a time within t5 (e.g., 100 us) after the second time offset Time-offset_2 at the start time of the second ranging slot (ranging slot 2). According to an embodiment, the second time offset may be set to be different from the first time offset. According to an embodiment, the second time offset may be set to 0. According to an embodiment, the first UWB device initiator 1 may transmit the RESP message for a time set so that the remaining time in the second ranging slot is t6 or more after transmitting the RESP message.

Each of the first UWB device initiator 1 and the second UWB device responder 1 may transmit an RSF and/or an RIF during the UWB transmission period (or the NB non-occupied period).

In the kth ranging slot (ranging slot k), the first UWB device initiator 1 may perform CCA for a time of t1 (e.g., 9 us) or more before transmitting the REPORT packet. If it is determined that the channel is clear as a result of the CCA, in the same kth ranging slot, the first UWB device initiator 1 may transmit a report message (initiator report) after a time of t2 (e.g., 10 us) or less elapses after the completion of the CCA. The first UWB device initiator 1 may transmit a report message (initiator report) for a time within t3 (e.g., 100 us) after the first time offset Time-offset_1 from the start time of the kth ranging slot. According to an embodiment, the first UWB device initiator 1 may transmit the report message (initiator report) for a time set so that the remaining time in the kth ranging slot is t4 or more after transmitting the report message (initiator report).

In the kth ranging slot, in the time period when the first UWB device initiator 1 transmits a report message (initiator report), the third UWB device initiator 2 may perform CCA. The third UWB device initiator 2 may detect the report message (initiator report) transmitted by the first UWB device initiator 1 and determine that the corresponding channel is busy as a result of CCA, and may not perform message transmission.

The second UWB device responder 1 may transmit a report message (responder report) for a time within t5 (e.g., 100 us) after the second time offset Time-offset_2 at the start time of the k+1th ranging slot (ranging slot k+1). According to an embodiment, the second time offset may be set to be different from the first time offset. According to an embodiment, the second time offset may be set to 0. According to an embodiment, the first UWB device initiator 1 may transmit the RESP message for a time set so that the remaining time in the k+1th ranging slot is t6 or more after transmitting the report message (responder report).

For convenience of description, FIG. 16C illustrates an example in which the first UWB device initiator 1 transmits a report message (initiator report transmission) and the second UWB device responder 1 transmits a report message (responder report). According to an embodiment, the first UWB device 1 may not transmit a report message (initiator report transmission) in the kth ranging slot. According to an embodiment, the second UWB device responder 1 may not transmit a report message (responder report) in the k+1th ranging slot. According to an embodiment, at least one of the report message (initiator report transmission) and the report message (responder report) may be transmitted.

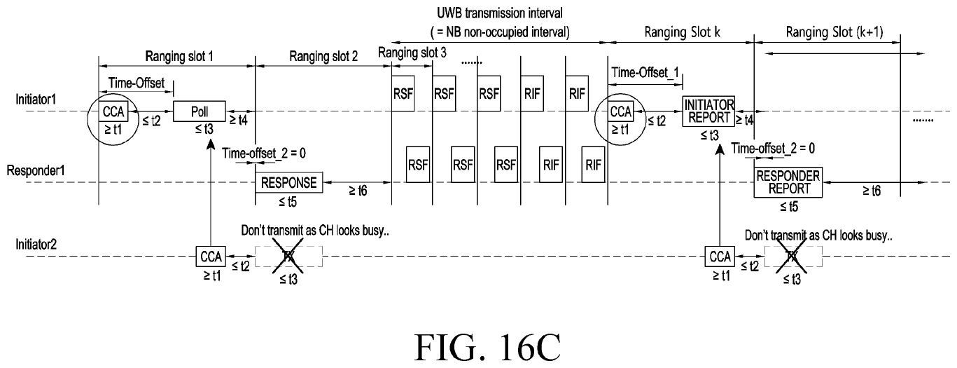

FIG. 17 illustrates a configuration of a first electronic device according to an embodiment of the disclosure.

The first electronic device of FIG. 17 may be the initiator device described above in FIGS. 8 to 16C. Referring to FIG. 17, the first electronic device may include a transceiver 1710, a controller 1720, and a storage unit 1730. In the disclosure, the controller may be defined as a circuit, an application-specific integrated circuit, or at least one processor.

The transceiver 1710 may transmit and receive a signal to and from another device. The transceiver 1710 may transmit/receive data to/from another UWB device through, e.g., NB communication, UWB communication or OOB communication (e.g., BLE communication).

The controller 1720 may control the overall operation of the first electronic device according to an embodiment. For example, the controller 1720 may control the signal flow between the blocks to perform the operations described in connection with FIGS. 1 to 16C.

According to an embodiment, the controller 1720 may perform clear channel assessment (CCA) for a plurality of slots within a ranging round to measure a state of a channel. The controller 1720 may control to transmit a poll message in a first ranging slot within the ranging round if it is determined, based on the CCA, that the channel is clear. The controller 1720 may receive, in a second ranging slot within the ranging round, a response message corresponding to the poll message from a second UWB device.

According to an embodiment, the controller 1720 may perform CCA to re-measure the state of the channel. The controller 1720 may control to transmit, in a third ranging slot within the ranging round, a first report message based on a UWB ranging result to the second UWB device if it is determined, based on the CCA, that the channel is clear.

According to an embodiment, the controller 1720 may receive, in a fourth ranging slot within the ranging round, a second report message based on the UWB ranging result from the second UWB device.

According to an embodiment, the controller 1720 may control to piggyback and transmit a first report message based on a UWB ranging result with the second UWB device on the poll message. According to an embodiment, the first report message may include a report round index field indicating which ranging round the report message is related to, a round-trip time field indicating a round-trip time according to the UWB ranging result, and a variable-length data field.

According to an embodiment, the poll message may include a report present field indicating whether the first report message based on the UWB ranging result of a previous round with the second UWB device is piggybacked.

According to an embodiment, the controller 1720 may receive, together with the response message, a second report message based on a UWB ranging result between the first UWB device and the second UWB device. According to an embodiment, the second report message may include a report round index field indicating which ranging round the report message is related to, a reply time field indicating a reply time according to the UWB ranging result, and a variable-length data field.

According to an embodiment, the response message may include a report present field indicating whether the second report message based on the UWB ranging result between the first UWB device and the second UWB device is piggybacked.

The storage unit 1730 may store at least one of information transmitted/received via the transceiver 1710 and information generated via the controller 1720. For example, the storage unit 1730 may store information and data necessary for the method described above with reference to FIGS. 1 to 16C.

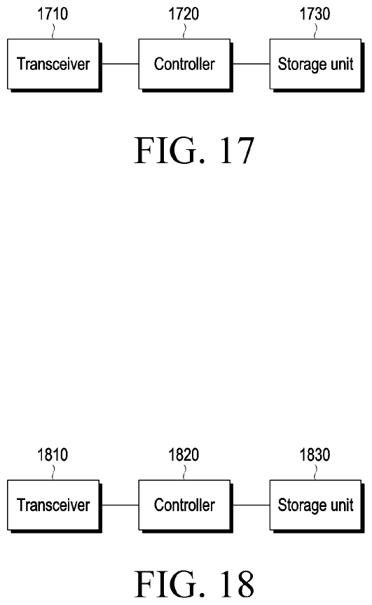

FIG. 18 illustrates a configuration of a second electronic device according to an embodiment of the disclosure.

The first electronic device of FIG. 18 may be the initiator device described above in FIGS. 8 to 16C. Referring to FIG. 18, the first electronic device may include a transceiver 1810, a controller 1820, and a storage unit 1830. In the disclosure, the controller may be defined as a circuit, an application-specific integrated circuit, or at least one processor.

The transceiver 1810 may transmit and receive a signal to and from another device. The transceiver 1810 may transmit/receive data to/from another UWB device through, e.g., NB communication, UWB communication or OOB communication (e.g., BLE communication).

The controller 1820 may control the overall operation of the first electronic device according to an embodiment. For example, the controller 1820 may control the signal flow between the blocks to perform the operations described in connection with FIGS. 1 to 16C.

According to an embodiment, the controller 1820 may receive, in a first ranging slot within a ranging round, a poll message from a first UWB device based on a clear channel assessment (CCA) for a plurality of slots within the ranging round of the first UWB device. The controller 1820 may control to transmit, in a second ranging slot within the ranging round, a response message corresponding to the poll message to the first UWB device.

The storage unit 1830 may store at least one of information transmitted/received via the transceiver 1810 and information generated via the controller 1820. For example, the storage unit 1830 may store information and data necessary for the method described above with reference to FIGS. 1 to 16C.

In the above-described specific embodiments, the components included in the disclosure are represented in singular or plural forms depending on specific embodiments provided. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Meanwhile, although specific embodiments of the present disclosure have been described above, various changes may be made thereto without departing from the scope of the present disclosure. Thus, the scope of the present disclosure should not be limited to the above-described embodiments, and should rather be defined by the following claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a first ultra-wideband (UWB) device operating as an initiator, the method comprising:
performing clear channel assessment (CCA) for a plurality of slots within a ranging round to measure a state of a channel;
transmitting a poll message in a first ranging slot within the ranging round based on a determination that the channel is clear according to the CCA; and
receiving, in a second ranging slot within the ranging round, a response message corresponding to the poll message, wherein the response message is received from a second UWB device.

2. The method of claim 1, further comprising:
performing the CCA to re-measure the state of the channel; and
transmitting, in a third ranging slot within the ranging round, a first report message based on a UWB ranging result, wherein the first report message is transmitted to the second UWB device based on a determination that the channel is clear according to the CCA.

3. The method of claim 2, further comprising receiving, in a fourth ranging slot within the ranging round, a second report message based on the UWB ranging result,
wherein the second report message is received from the second UWB device.

4. The method of claim 1, further comprising piggybacking and transmitting a first report message based on a UWB ranging result with the second UWB device on the poll message,
wherein the first report message includes a report round index field indicating which ranging round a report message is related to, a round-trip time field indicating a round-trip time according to the UWB ranging result, and a variable-length data field.

5. The method of claim 1, wherein the poll message includes a report present field indicating whether a first report message, based on the UWB ranging result with the second UWB device, is piggybacked.

6. The method of claim 1, further comprising receiving, together with the response message, a second report message based on a UWB ranging result between the first UWB device and the second UWB device,
wherein the second report message includes a report round index field indicating which ranging round a report message is related to, a reply time field indicating a reply time according to the UWB ranging result, and a variable-length data field.

7. The method of claim 1, wherein the response message includes a report present field indicating whether a second report message based on the UWB ranging result between the first UWB device and the second UWB device is piggybacked.

8. A method of a second ultra-wideband (UWB) device operating as a responder, the method comprising:
receiving, in a first ranging slot within a ranging round, a poll message from a first UWB device based on a clear channel assessment (CCA) for a plurality of slots within the ranging round of the first UWB device; and
transmitting, in a second ranging slot within the ranging round, a response message corresponding to the poll message, wherein the response message is transmitted to the first UWB device.

9. The method of claim 8, further comprising receiving, in a third ranging slot within the ranging round, a first report message based on a UWB ranging result, the first report message is received from the first UWB device based on the CCA of the first UWB device.

10. The method of claim 9, further comprising transmitting, in a fourth ranging slot within the ranging round, a second report message based on the UWB ranging result, wherein the second report message is transmitted to the first UWB device.

11. The method of claim 8, further comprising receiving, together with the poll message, a first report message based on a UWB ranging result with the second UWB device,
wherein the first report message includes a report round index field indicating which ranging round a report message is related to, a round-trip time field indicating a round-trip time according to the UWB ranging result, and a variable-length data field.

12. The method of claim 8, wherein the poll message includes a report present field indicating whether a first report message, based on the UWB ranging result with the second UWB device, is piggybacked.

13. The method of claim 8, further comprising piggybacking and transmitting a second report message based on a UWB ranging result between the first UWB device and the second UWB device on the response message,
wherein the second report message includes a report round index field indicating which ranging round a report message is related to, a reply time field indicating a reply time according to the UWB ranging result, and a variable-length data field.

14. The method of claim 8, wherein the response message includes a report present field indicating whether a second report message based on the UWB ranging result between the first UWB device and the second UWB device is piggybacked.

15. A first ultra-wideband (UWB) device operating as an initiator, comprising:
a transceiver; and
a controller, wherein the controller operably coupled to the transceiver, the controller configured to:
perform clear channel assessment (CCA) for a plurality of slots within a ranging round to measure a state of a channel;
control to transmit a poll message in a first ranging slot within the ranging round based on a determination that the channel is clear according to the CCA; and
receive, in a second ranging slot within the ranging round, a response message corresponding to the poll message, wherein the response message is received from a second UWB device.

16. The first UWB device of claim 15, wherein the controller is further configured to:
perform the CCA to re-measure the state of the channel; and
control to transmit, in a third ranging slot within the ranging round, a first report message based on a UWB ranging result, wherein the first report message is transmitted to the second UWB device based on a determination that the channel is clear according to the CCA.

17. The first UWB device of claim 15, wherein the controller is further configured to control to piggyback and transmit a first report message based on a UWB ranging result with the second UWB device on the poll message, and
wherein the first report message includes a report round index field indicating which ranging round a report message is related to, a round-trip time field indicating a round-trip time according to the UWB ranging result, and a variable-length data field.

18. The first UWB device of claim 15, wherein the poll message includes a report present field indicating whether a first report message based on the UWB ranging result with the second UWB device is piggybacked.

19. A second ultra-wideband (UWB) device operating as a responder, comprising:
a transceiver; and
a controller, wherein the controller operably coupled to the transceiver, the controller configured to:
receive, in a first ranging slot within a ranging round, a poll message from a first UWB device based on a clear channel assessment (CCA) for a plurality of slots within the ranging round of the first UWB device; and
control to transmit, in a second ranging slot within the ranging round, a response message corresponding to the poll message, wherein the response message is transmitted to the first UWB device.

20. The second UWB device of claim 19, wherein the controller is configured to control to piggyback and transmit a second report message based on a UWB ranging result between the first UWB device and the second UWB device on the response message, and
wherein the second report message includes a report round index field indicating which ranging round a report message is related to, a reply time field indicating a reply time according to the UWB ranging result, and a variable-length data field.
